(19) United States
(12) Patent Application Publication
(10) Pub. No.: US 2025/0052915 A1
(43) Pub. Date: Feb. 13, 2025

(54) X-Ray Detection Structure with a Plurality of Scintillator Volumes in a Spatially Periodic Arrangement

(71) Applicant: Viken Detection Corporation, Burlington, MA (US)

(72) Inventor: Peter J. Rothschild, Newton, MA (US)

(21) Appl. No.: 18/718,527

(22) PCT Filed: Dec. 17, 2022
(86) PCT No.: PCT/US2022/081897

§ 371 Date: Jun. 11, 2024

Related U.S. Application Data
(60) Provisional application No. 63/265,647, filed on Dec. 17, 2021.
(60) Provisional application No. 63/268,283, filed on Feb. 21, 2022.

(51) Int. Cl. G01T 1/20; G01N 23/203

(52) U.S. Cl. CPC G01T 1/20185; G01N 23/203

(57) ABSTRACT

An x-ray detection structure includes a plurality of scintillator volumes in a spatially periodic arrangement, the plurality of scintillator volumes spaced from each other and forming a scan axis at which x-rays from a scanning beam of x-rays transmitted through a target can be received. The scintillator volumes produce scintillation photons responsive to receiving the x-rays. The structure also includes a wavelength-shifting fiber (WSF) ribbon optically coupled to the plurality of scintillator volumes along the scan axis. The WSF ribbon receives scintillation photons from the plurality of scintillator volumes as the scanning beam of x-rays scans and causes at least a subset of scintillator volumes to produce the scintillation photons. A multi-layer version of the structure, corresponding x-ray detection systems, and corresponding methods of manufacturing can be used to produce higher-resolution x-ray images in a compact detector with ease of manufacturability.

### RELATED APPLICATIONS

This application claims the benefit of U.S. Provisional Application No. 63/268,283, filed on Feb. 21, 2022, and U.S. Provisional Application No. 63/265,647, filed on Dec. 17, 2021. The entire teachings of the above applications are incorporated herein by reference.

### BACKGROUND

The use of backscatter X-ray imaging for security applications is becoming more widespread for border security and for infrastructure protection. These systems benefit from the use of scanning pencil beams of X-rays to form scatter images and do not require fan beams of radiation as are typically used in transmission imaging systems. In addition to creating backscatter image(s) with one or more scanning beams, it is desirable to use the same scanning beam(s) of x-ray radiation to create transmission images, including based on the same scan(s).

### SUMMARY

Using a scanning pencil beam is unlike using a fan beam with which a segmented array of detector elements may be used on the far side of the target object (the side of the target object opposite the x-ray beam source) to create a transmission image. A pencil beam of radiation typically requires the use of a large monolithic scintillating medium on the far side of the object to intercept the beam. For example, in drive-through backscatter X-ray portals, a long length of plastic scintillator has been used as a transmission detector to detect X-rays transmitted through the object in one of more of the X-ray views. Dual-energy versions of these large monolithic detectors have been developed.

Some dual-energy versions of the large monolithic detectors that have been developed to be used for transmission detection with a scanning pencil beam use wavelength-shifting fibers (WSFs) to read out the scintillator. For example, two separated channels of scintillating medium have been read out using wavelength-shifting fibers to collect the light generated by the scintillators during X-ray impact and direct the scintillation light onto a photodetector such as a Photo-Multiplier Tube (PMT). The first scintillation medium has been placed closest to the X-ray source and is sensitive to the lower-energy X-rays in the transmitted beam. A second scintillation medium has been placed so that it can intercept the X-rays transmitted through the first scintillation medium and is sensitive to the higher-energy X-rays in the transmitted beam. A filter material can be placed between the two media to enhance the detector's ability to perform spectral discrimination, and therefore improve the material-discrimination capability of the imaging system. Alternatively, it is known for the scintillation light from the first scintillation medium to be collected with WSF and for the scintillation light from the second scintillation medium to be read out by other means. The other means can include, for example, a non-wavelength-shifting light guide, such as a piece of plastic scintillator (which can act as both the scintillator and the light guide). The use of a dual-energy WSF detector on a handheld X-ray instrument has been proposed.

Each of these detector designs has advantages and disadvantages. WSF implementation on both the low and high-energy channels leads to a compact, low-profile design but can be a more expensive approach due to the cost of the fibers. The use of plastic scintillator in the high-energy channel of the second design leads to a larger, less-compact detector.

WSF has been used as a convenient means to read out the scintillation light from various types of X-ray detectors. However, the performance of the detectors remains to be enhanced in many respects. A WSF readout method has been proposed to improve the resolution of an imaging system that uses a scanning beam of X-rays. The method involves using two layers of parallel wavelength shifting fibers (one of which loops in and out of a scintillation region), each with a different resolution, and each read out using a multi-anode photomultiplier tube (PMT). The low-resolution layer produces a signal that yields the crude location of the X-ray beam on the detector. The signals from the high-resolution layer yield the distribution of transmitted radiation within that crude location, allowing for higher resolution images to be obtained.

Reference may be made to pending PCT App. No. PCT/US2021/047030, filed on Aug. 20, 2021, titled “X-Ray Detection Structure and System” (Attorney Docket No. 5260.1014-001), which is hereby also incorporated herein by reference in its entirety. The PCT/US2021/047030 application describes relatively low-cost, compact, dual-energy transmission detectors optimized for use with scanning pencil beams of X-rays, as used in backscatter imaging applications. The detectors disclosed therein, in their simplest form, may include a single volume of scintillator spanning the length of the detector, coupled optically to multiple “ribbons” of wavelength shifting fibers (WSF) for collecting the scintillation light, where the fibers shift the scintillation light to a longer wavelength to allow for effective transmission along the fibers. A “ribbon” is defined for the purposes of this disclosure as a set of one or more fibers (either a single fiber or two or more fibers) oriented in a configuration wherein the fibers are substantially parallel to each other. At least one end of each of the ribbons can be optically coupled to a photodetector such as a photomultiplier tube (PMT). The multiple ribbons can be wrapped helically in a repeating sequence around a supporting structure, and over (or under) the strip of scintillator that can run the entire active length of the detector. As the beam is swept across the detector, the intensity of the scintillation light as a function of position along the scintillator volume is sampled by the separate WSF ribbons, allowing the number of x-rays absorbed in the scintillator to be measured as a function of position along the detector. Since the combined width of the individual ribbons can be substantially less than the width of the beam illuminating the detector, substantially higher resolution can be obtained in the resulting image if the signal from only a subset of the ribbons is used to select the centroid of the beam, while excluding the wide tails of the beam.

In contrast to the embodiments described in pending patent application PCT/US2021/047030, embodiments disclosed in this application use a novel means of reading out the scintillation light from a repeating pattern of scintillator volumes to provide higher resolution transmission images, even on a system that uses a wide scanning beam of x-rays.

A significant difference between embodiments disclosed in this application and those of PCT/US2021/047030 is that the scintillator volumes themselves exhibit a repeating structure, rather than a repeating structure in the light readout portion. While both approaches can yield transmission images of higher resolution, embodiments of the current application include significant further advantages in terms of ease of manufacturability and compactness of the detector. Another advantage of embodiments of the current application is that the current embodiments can include linear WSF ribbons that do not require helical wrapping. As a result, the fibers can have far fewer bends, resulting in less loss of the light signals prior to detection.

Accordingly, in one specific embodiment, an x-ray detection structure includes:
a plurality of scintillator volumes in a spatially periodic arrangement, the plurality of scintillator volumes spaced from each other and forming a scan axis at which x-rays from a scanning beam of x-rays transmitted through a target can be received, the plurality of scintillator volumes configured to produce scintillation photons responsive to receiving the x-rays; and
a wavelength-shifting fiber (WSF) ribbon optically coupled to the plurality of scintillator volumes along the scan axis, the WSF ribbon configured to receive scintillation photons from the plurality of scintillator volumes as the scanning beam of x-rays scans and causes at least a subset of scintillator volumes in the scan axis to produce the scintillation photons.

In another embodiment, a method of manufacturing an x-ray detection structure includes:
situating a plurality of scintillator volumes in a spatially periodic arrangement, spaced from each other, thus forming a scan axis at which x-rays from a scanning beam of x-rays transmitted through a target can be received, the scintillator volumes configured to produce scintillation photons responsive to receiving the x-rays; and
optically coupling a wavelength-shifting fiber (WSF) ribbon to the plurality of scintillator volumes along the scan axis such that the WSF ribbon can receive scintillation photons from the plurality of scintillator volumes via the optical coupling as the scanning beam of x-rays scans over the scan axis.

In a further embodiment, an x-ray detection structure includes:
a plurality of detection layers, each respective detection layer comprising:
a plurality of detection layers, each respective detection layer comprising:
a scintillator sub-layer having a plurality of scintillator volumes in a spatially periodic arrangement, the plurality of scintillator volumes spaced from each other and forming a scan axis at which x-rays from a scanning beam of x-rays transmitted through a target can be received, the plurality of scintillator volumes further configured to produce scintillation photons responsive to receiving the x-rays;
a plurality of spacers in the scintillator sub-layer in a spatially periodic arrangement in the scan axis, the spacers configured to transmit x-rays from the scanning beam transmitted through the target, one or more respective spacers of the plurality of spacers situated between respective pairs of adjacent scintillator volumes of the plurality of scintillator volumes, the spacers being substantially transparent to x-rays;
a wavelength-shifting fiber (WSF) ribbon sub-layer optically coupled to the plurality of scintillator volumes along the scan axis, the WSF ribbon configured to receive scintillation photons from the plurality of scintillator volumes as the scanning beam of x-rays scans and causes at least a subset of scintillator volumes in the scan axis to produce the scintillation photons; and
a reflective sub-layer comprising a light reflector mechanically fixed with respect to the WSF ribbon and the plurality of scintillator volumes and configured to isolate, optically, the detection layer from other detection layer(s) of the plurality of detection layers.

Variations of the above-noted embodiments, including x-ray detection systems and other multi-layer x-ray detection structures and methods of manufacturing, will become apparent from the various drawings and the detailed description.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a schematic illustration of an embodiment detector system, for detecting a scanning beam of x-rays.

FIG. 2 (prior art) is a perspective illustration of an existing x-ray imaging system using a fan beam of x-rays incident on a linear segmented detector array.

FIG. 3 (prior art) is a perspective illustration of an x-ray imaging system using a cone beam of x-rays incident on a two-dimensional segmented detector array.

FIG. 4 (prior art) is an illustration of an existing x-ray imaging system utilizing a narrow scanning beam of x-rays.

FIG. 5 (prior art) is an illustration of an existing x-ray imaging system utilizing a wide scanning beam of x-rays.

FIG. 6 illustrates a novel embodiment system similar to that of FIG. 5, except using detector segmentation that produces higher-resolution images even with a wide x-ray scanning beam.

FIG. 7 is a perspective illustration of an embodiment x-ray detection system have a tubular support structure and spatially repeating series of WSF ribbons utilizing a wide scanning beam of x-rays with a detector readout system including a spatially repeating series of WSF ribbons that produces higher-resolution images.

FIGS. 8A-8C are wide scanning beam profiles illustrating various beam segments that may be combined selectively by choosing signals from the WSF ribbons in FIG. 7 to achieve varying degrees of image resolution and/or penetration.

FIG. 9 illustrates results of a computer simulation showing images of a line pair phantom acquired with a standard prior-art detector (left), a detector with 0.75″ wide ribbons (center), and a detector with 0.5″ wide ribbons (right).

FIG. 10 is a perspective illustration of an embodiment dual-energy, high-resolution x-ray detector structure for use with a scanning x-ray beam as viewed from the direction of the incident beam.

FIGS. 11A-11B illustrated embodiment detector structures adapted for use in an area panel detector.

FIG. 12 is a schematic drawing illustrating respective photodetectors optically coupled to respective WSF ribbons that are wrapped around a tubular support structure according to an embodiment x-ray detector structure or system.

FIG. 13 is a block flow diagram illustrating functions of a signal combiner that may be used in embodiment x-ray detection systems.

FIG. 14A is a cross-sectional illustration of an embodiment dual-energy detector with a tubular support structure and separate scintillator volumes for high-energy and low-energy channels, which correspond preferentially to high-energy and low-energy x-rays, respectively.

FIG. 14B is a cross-sectional illustration of an embodiment dual-energy detector with a tubular support structure and a common, shared scintillator volume for high-energy and low-energy x-ray channels.

FIG. 15 is a profile-view illustration of an embodiment light-detection structure that has WSF ribbons wrapped around a curved outer surface of a tubular support structure.

FIG. 16 is a cross-sectional view of a tubular support structure having a circular cross section providing a curved outer surface.

FIG. 17 is a cross-sectional view of a tubular support structure having an oval cross section providing a curved outer surface.

FIG. 18 is a cross-sectional view of a tubular support structure having an irregular cross section providing a curved outer surface.

FIG. 19 (prior art) is a cross-sectional illustration of an existing dual-energy x-ray detector structure using two scintillator volumes, each read out by a plurality of WSF fibers.

FIG. 20 (prior art) is a perspective view of the same existing detector structure as in FIG. 19.

FIG. 21 (prior art) is a cross-sectional illustration of an alternative existing detector structure using two scintillator volumes, the first read out with a plurality of WSF fibers, and the second read out using other means.

FIG. 22 is a schematic illustration of an embodiment detector system for determining a characteristic of an energy spectrum of x-rays.

FIG. 23 is cross-sectional view illustration of certain components of an embodiment detector system showing a scintillator volume used for both low-energy and high-energy channels in accordance with a preferred embodiment, with a central region of the detector, the scintillator volume, acting as a virtual filter (also referred to herein as an “effective self-filter”) for enhancing energy discrimination.

FIG. 24 is a graph illustrating simulated relative light output from a 500 mg/cm² volume of BaFCl with WSF layers on the entrance and exit surfaces.

FIG. 25 is cross-sectional view illustration of certain components of an embodiment detector system, tilted with respect to the incident x-ray beam to increase detection efficiency.

FIG. 26 is a cross-sectional view illustration of certain components of an embodiment detector system optimized for area detection such as use in backscatter imaging.

FIG. 27 is a schematic diagram illustrating a side view of an embodiment x-ray detection structure.

FIG. 28 is a side view of an example embodiment x-ray detection structure having for detection layers with four respective scintillator sub-layers and four respective WSF ribbon sub-layers, with other elements.

FIG. 29 is a top view of the x-ray detection structure of FIG. 28, at various example stages or steps of assembly or manufacture.

FIG. 30 is a perspective view of an existing handheld x-ray imaging system similar to that of FIGS. 11A-11B, except used in an embodiment system with an embodiment x-ray detection structure adapted for use as an area detector for high resolution transmission imaging.

FIG. 31 is a schematic diagram illustrating an embodiment signal combiner that allows individual channels of data to be combined using a calibration lookup table (LUT) on a pixel-by-pixel basis to create a high-resolution image for display.

FIG. 32 is a series of images showing results of a computer simulation showing images of a line pair phantom acquired with a standard prior art detector (left), an embodiment detector with 0.75 inch wide strips of scintillator volume (center), and with 0.5 inch wide strips (right side).

FIG. 33 is a side view illustration of an embodiment x-ray detection structure with dual energy operation, four layers of scintillator strips volumes, and eight WSF ribbons.

FIG. 34 is an end-view, perspective diagram of an embodiment x-ray detection system that includes the x-ray detection structure of FIG. 33, showing optical coupling of LE WSF ribbons to individual photodetectors and all of the HE WSF ribbons optically coupled together to a single photodetector.

FIG. 35 is a flow diagram illustrating an embodiment method for manufacturing an x-ray detection structure.

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

### DETAILED DESCRIPTION

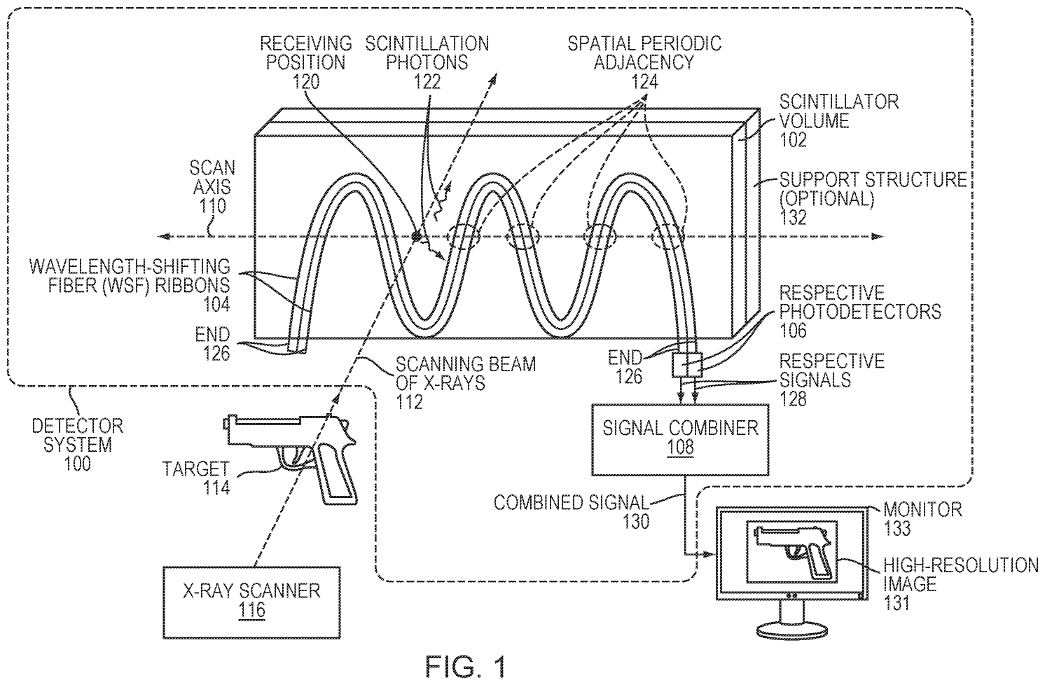

A description of example embodiments follows.

[FIGS. 1-26 correspond to FIGS. 1-26 of PCT App. No. PCT/US2021/047030, filed on Aug. 20, 2021, titled “X-Ray Detection Structure and System” (Attorney Docket No. 5260.1014-001), to which reference is useful in considering the presently disclosed embodiments. In specific reference to FIGS. 1-26, the term “embodiment” refers to an embodiment of PCT Pat. App. No. PCT/US2021/047030.]

Summary of PCT App. No. PCT/US2021/047030 (in Part)

As one example of a large monolithic scintillating medium, in drive-through backscatter x-ray portals, a long length of plastic scintillator has been used as a transmission detector to detect x-rays transmitted through the object in one of more of the x-ray views. Dual-energy versions of these large monolithic detectors have been used. Each of the previously known detector designs has advantages and disadvantages. For example, wavelength-shifting fiber (WSF) implementation on both low- and high-energy channels leads to a compact, low-profile design but tends to be an expensive approach, as the WSFs are expensive to manufacture. The use of plastic scintillator in the high-energy channel of the second design leads to a larger, less-compact and less-expensive detector.

WSF has been used as a convenient means to read out the scintillation light from various types of x-ray detectors, but not to enhance the performance of the detector otherwise.

Some embodiments disclosed in this application relate to the design of a relatively low-cost, compact, dual-energy transmission detector optimized for use with scanning pencil beams of x-rays, as used in backscatter imaging applications. Embodiments can have higher imaging resolution than systems that use equivalent x-ray scanning beam but which use prior art x-ray detector systems. Embodiments in their simplest form may include a single channel, single-energy detector that includes a scintillator screen coupled optically to multiple “ribbons” of wavelength shifting fibers (WSF) for collecting the scintillation light, where the fibers shift the scintillation light to a longer wavelength to allow for effective transmission along the fibers. As used herein, a “ribbon” is a set of one or more fibers—either a single fiber, or two or more fibers oriented in a configuration wherein the fibers are substantially parallel to each other. At least one end of each of the ribbons is optically coupled to a photodetector, such as a photomultiplier tube (PMT).

One embodiment includes a detector optimized for use with a scanning beam of x-rays. The detector includes:
a plurality of ribbons of wavelength-shifting fibers optically coupled to one or more scintillator volumes, wherein the ribbons are arranged to couple to the scintillator volume in a repeating pattern along one or more axes of the detector;
at least one photodetector coupled to one or more ends of each of the ribbons for detecting scintillation photons;
a signal combiner for combining the signals from one or more of the ribbons for each orientation of the scanning beam to create a combined signal for each beam orientation; and
a processor for creating an image from the combined signals.

The signal combiner may be a lookup table or other means for combining the signals from one or more of the ribbons for each orientation of the scanning beam to create a combined signal for each beam orientation.

In one particular embodiment, a detector system for detecting a scanning beam of x-rays, the detector system includes one or more scintillator volumes configured to be oriented along a scan axis of a scanning beam of x-rays. The volume(s) are configured to receive x-rays from the scanning beam transmitted through a target, as well as to produce scintillation photons responsive to receiving the x-rays.

The system also includes a plurality of ribbons of wavelength-shifting fibers (WSFs) optically coupled to the one or more scintillator volumes along the scan axis via a spatial periodic adjacency of the plurality of ribbons to the scan axis. The ribbons are configured to receive scintillation photons from the scintillator volume(s) via the spatial periodic adjacency as the scanning beam of x-rays scans over the scan axis.

The system also includes at least one respective photodetector coupled to an end of each respective ribbon of the plurality of ribbons. Each respective photodetector is configured to detect the scintillation photons carried by the respective ribbon and to produce a respective signal responsively.

The system further includes a signal combiner configured to combine, selectively, respective signals from one or more ribbons of the plurality of ribbons, for positions of the scanning beam along the scan axis, to create a combined signal representing a scan of the target. The combined signal can represent the scan with enhanced spatial resolution.

In another embodiment, a light detection structure includes a tubular support structure having a curved outer surface. The light detection structure further includes a plurality of ribbons of wavelength-shifting fibers (WSFs) wrapped around the curved outer surface in a spatially periodic, substantially helical pattern. The plurality of ribbons of WSFs are configured to carry light to be detected at respective ends of respective ribbons of the plurality of ribbons.

In a further embodiment, an x-ray detection structure includes the light detection structure described above. The tubular support structure is comprised of one or more scintillator volumes configured to receive x-rays from an x-ray scanning beam. The scintillator volume(s) are optically coupled to the plurality of ribbons. The light to be detected includes scintillation photons produced by the one or more scintillator volumes responsive to receiving the x-rays from the x-ray scanning beam.

An alternative embodiment x-ray detection structure still includes the light detection structure described above. The scintillator volume(s) may be mechanically coupled to the tubular support structure, optically coupled to the plurality of ribbons of WSF, and configured to receive x-rays and to produce scintillation photons responsively. The WSF ribbons are configured to receive the scintillation photons and to convert the scintillation photons to the light to be detected.

In still a further embodiment, a detector system is configured to determine a characteristic of an energy spectrum of x-rays. The system includes a scintillator volume having an entrance surface and an exit surface. The entrance surface is configured to receive incident x-rays. The scintillator volume is configured to emit scintillation light responsive to the incident x-rays, and the exit surface is configured to pass a portion of the incident x-rays that traverse a thickness of the scintillator volume between the entrance surface and the exit surface.

The detector system further includes a first plurality of light guides optically coupled to the entrance surface of the scintillator volume. The system also includes a second plurality of light guides optically coupled to the exit surface of the scintillator volume.

In addition, the detector system includes at least one first photodetector optically coupled to an end of the first plurality of light guides and configured to output a first signal responsive to scintillation light from the scintillator volume. The detector system further includes at least one second photodetector optically coupled to an end of the second plurality of light guides and configured to output a second signal responsive to scintillation light from the scintillator volume.

In addition, the detector system includes a spectrum analyzer that is configured to receive the first and second signals responsive to the scintillation light from the scintillator volume and to determine a characteristic of an energy spectrum of the incident x-rays based on the first and second signals.

Detailed Description of PCT App. No. PCT/US2021/047030 (in Part)

FIG. 1 is a schematic illustration of an embodiment detector system for detecting a scanning beam of x-rays. The detector system 100 includes a scintillator volume 102, a plurality of wavelength shifting fiber (WSF) ribbons 104, respective photodetectors 106, and a signal combiner 108. The scintillator volume 102 is configured to be oriented along a scan axis 110 of a scanning beam of x-rays 112 that is transmitted through a target 114. The “scan axis” is also referred to herein as “scanning axis,” “scanner axis,” and the like. As one example, the scanning beam 112 may be received from an x-ray scanner 116, which can include a pencil beam scanning apparatus that is used for backscatter imaging and or transmission imaging, as is known in the art of x-ray scanning. The scintillator volume 102 is further configured to produce scintillation photons 122 responsive to receiving x-rays from the scanning beam of x-rays 112. The scintillator volume 102 illustrated in FIG. 1 can be replaced by more than one scintillator volume. In this case, scintillator volumes may be attached to each other contiguously or may have some separation between them.

A common feature of embodiments including aa single scintillator volume 102 or multiple scintillator volumes is that the WSF ribbons 104 are optically coupled to the one or more scintillator volumes along the scan axis 110 via a spatial periodic adjacency 124 of the ribbons 104 to the scan axis 110. As indicated above, the scanning beam of x-rays 112 is received at the scintillator volume 102 at various positions along the scanner axis 110. For example, a receiving position 120 is illustrated in FIG. 1. As the scanning beam interacts with the scintillator volume 102, the scintillation photons 122 are produced, and the scintillation photons (also referred to herein as “scintillation light,” “light,” and the like) will propagate in various directions through the scintillator volume 102. Some of the scintillation photons 122 will be optically coupled into fibers of the WSF ribbons 104. This optical coupling occurs predominantly and especially at receiving positions 120 where the ribbons 104 are adjacent to the scan axis. Example positions of spatial periodic adjacency 124 are illustrated in FIG. 1, where the optical coupling predominantly occurs. The plurality of ribbons 104 is configured to receive scintillation photons 122 from the one or more scintillator volumes via the spatial periodic adjacency 124 as the scanning beam of x-rays 112 scans over the scan axis.

In the embodiment of FIG. 1, the detector system 100 includes one respective photodetector 106 corresponding to each of the two WSF ribbons 104. However, in other embodiments, more than one respective photodetector 106 may be provided for each WSF ribbon 104. Each reason 104 may include a single WSF fiber or multiple WSF fibers. In the case of multiple WSF fibers in a given WSF ribbon 104, a photodetector may be configured to detect light carried by each WSF fiber of the respective WSF ribbon 104, for example. Nonetheless, multiple fibers in a WSF ribbon may have the light carried therein detected by the same respect respective photodetector 106.

The respective photodetectors 106 are coupled to respective and 126 of each respective ribbon of the plurality of ribbons 104. Each respective photodetector 106 is configured to detect scintillation photons 122 that are carried by the respective WSF ribbon 104. Each photodetector 106 responsively produces a respective signal 128, and these respective signals 128 are received by the signal combiner 108.

The signal combiner 108 is configured to combine, selectively, the respective signals 128 from one or more ribbons 104 of the plurality of rhythms. This combination that is selective occurs for positions of the scanning beam 112 along the scan axis 110. In this manner, a combined signal 130 is created by the signal combiner 108, and the combined signal 130 represents a scan of the target 114 with enhanced spatial resolution.

As described further hereinafter, the scanning beam 112 will have a particular beam width at the scanner axis 110, which is an axis along which the scanning beam 112 intersects with the scintillator volume 102. Prior art systems would typically be limited to a spatial resolution for an x-ray scan that is similar to the beam width of the scanning beam at the scanner axis 110. In other words, a positional uncertainty would be on the order of the size of the beam width at the scanner axis 110.

However, consistent with the detector system 100 and other embodiments described herein, a high-resolution scan may be obtained, with higher spatial resolution than would normally be obtained given the beam width. In other words, a positional uncertainty of the scanning beam 112 may be significantly smaller than the beam width of the scanning beam 112 at the scanner axis 110 through the scintillator volume. As illustrated in FIG. 1, the combined signal 130 may be used to create a high-resolution line scan, or multiple high-resolution line scans, such that a high-resolution image 131 of the target 114 can be created. In FIG. 1, the high-resolution image 131 is shown displayed on a monitor 133, for example.

In the schematic an illustration of FIG. 1, the spatial periodic adjacency 124 of the ribbons 104 to the scanner axis 110 in the scintillator volume 102 is achieved by way of the WSF ribbons 104 intersecting a path of the scanning beam of x-rays 112 in various periodic positions as the beam propagates toward the scanner axis 110 in the scintillator volume 102. The schematic FIG. 1 suggests the fiber ribbons 104 lie flat against the scintillator volume 102 at all positions. This need not necessarily be the case, however. In some embodiments, the WSF ribbons 104 can lie flat against the scintillator volume 102 only at the positions of spatial periodic adjacency 124, for example. The schematic FIG. 1 suggests that the spatial periodic adjacency 124 can be precisely periodic. However, while precise periodicity can be desirable, which precise spatial periodicity is not required in all embodiments.

Scintillation photons or scintillation light, as used herein, also referred to light that has been wavelength shifted in the WSF fibers and propagates therein to be detected by the respective photodetectors 106.

FIG. 1 also illustrates an optional support structure 132 the scintillator volume 102 and the WSF ribbons 104 can be mechanically coupled, such as being a fixed directly or indirectly, to the support structure 132. However, in other embodiments, the scintillator volume 102 forms a support structure to which the WSF ribbons 104 are mechanically coupled (e.g., affixed directly or indirectly). In particular, it is known that plastic scintillators can be formed into various convenient shapes and can also be formed with a sufficient, desirable rigidity to maintain spatial precision.

Schematic FIG. 1 illustrates the scintillator volume 102 as and the support structure 132 as being rectangular. However, in various embodiments, both the scintillator volume 102 and optional support structure 132 can take various forms that allow the scintillator volume 102 to be oriented along the scan axis 110, and also permit the WSF ribbons 104 to be oriented with respect to the scintillator volume 102 to achieve the spatial periodic adjacency 124. For example, in highly advantageous embodiments described hereafter, the optional support structure is tubular, and the scintillator volume 102 is a strip of scintillator material that is only wide enough to reliably encompass or capture the x-ray scanning beam 112 along the scan axis 110. Furthermore, the scintillator volume 102 itself can form a support structure and can be tubular in some embodiments.

The respective photodetectors 106 can be photomultiplier tubes (PMTs), for example.

The signal combiner 108 can be software operating on a computer system, such as a computer system that is used for controlling and displaying x-ray scanning, for example. In other embodiments, the signal combiner 108 can be a firmware routine operating in an embedded processing environment, for example.

A single scan along the scanner axis 110 can be a line scan, and a two-dimensional scan may be obtained by translating the target 114 or the x-ray scanner 116. In a case where the x-ray scanner 116 is translated, with respect to the target 114, the scintillator volume 102 and WSF ribbons 104 can be translated together with the scanner 116, for example.

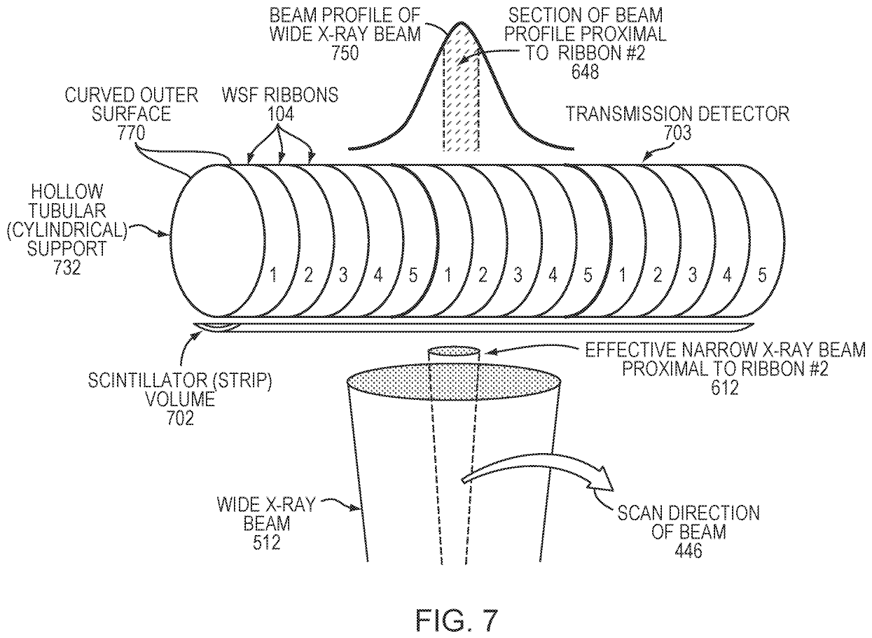

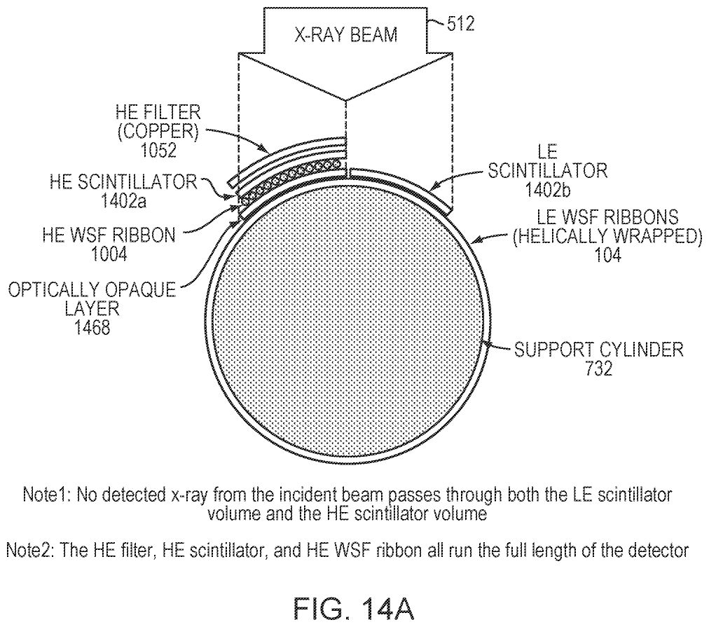

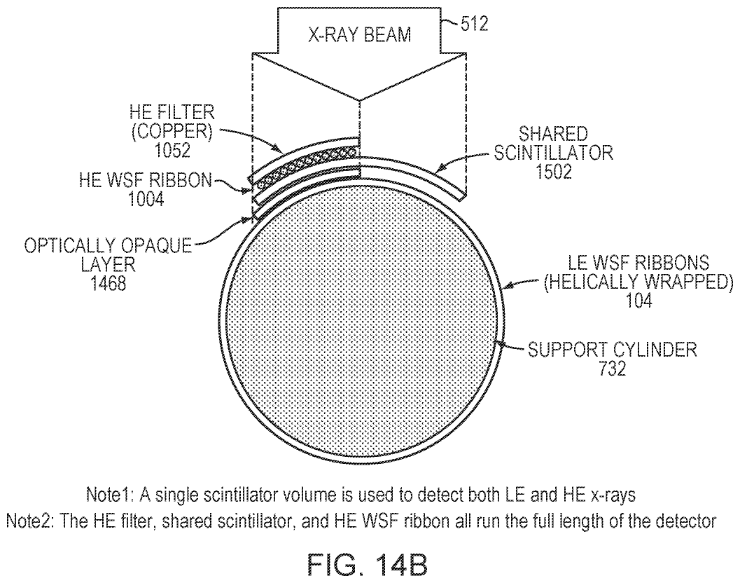

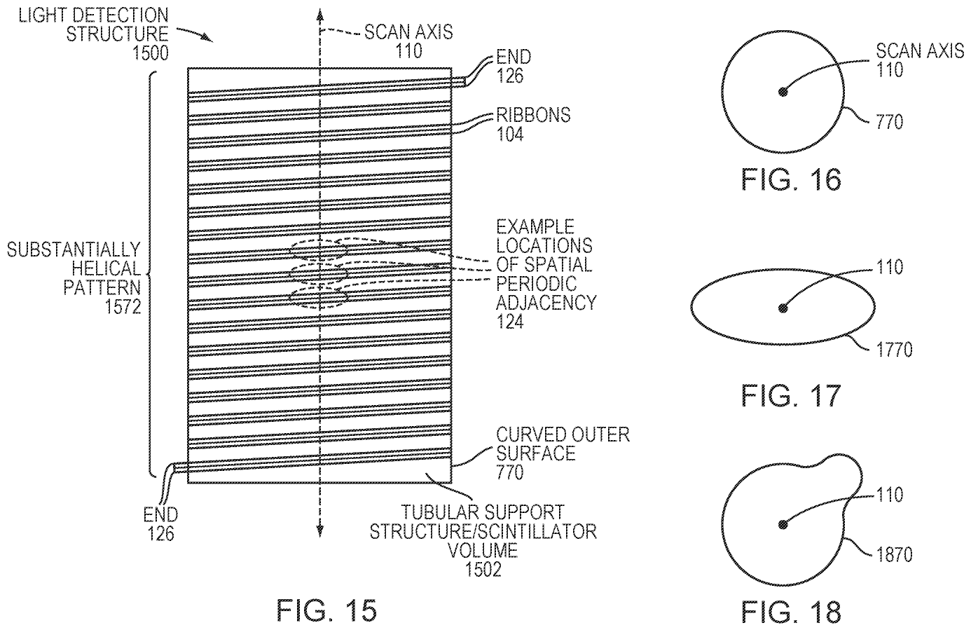

Characteristics of particular embodiments and variations of the detector system 100 will become apparent by reference to other drawings and the remainder of this description. In particular, the one or more scintillator volumes can itself or themselves form a support structure to which the plurality of ribbons are mechanically coupled, such as being directly affixed or indirectly coupled thereto, and FIG. 15 provides one example. As an alternative, the detector system may include a support structure as a component that is distinct from the scintillator volume(s) to which the volume(s) and the plurality of ribbons can be mechanically coupled directly or indirectly, and FIGS. 7, 14A, and 14B, among other drawings, are exemplary.

The support structure can be a tubular support structure having a curved outer surface, such as the embodiments illustrated in FIGS. 7, 10, 12, 14A, 14B, and FIGS. 15-18. The plurality of ribbons mechanically coupled to the support structure can be wrapped around the curved outer surface of the tubular support structure in a substantially helical pattern to form the spatial periodic adjacency, as illustrated in FIGS. 7 and 15, for example, and especially in FIG. 15, which illustrates an example helical pattern with greater clarity. A tubular support structure may be solid or may have a hollow interior core.

The detector system may have a first ribbon and a second ribbon of the plurality of ribbons considered to be low-energy channel and high-energy channels, respectively, configured to receive scintillation photons produced by relatively lower-energy x-rays and relatively higher-energy x-rays, respectively, interacting with the one or more scintillator volumes. Scintillation photons carried by the high-energy channel can represent x-rays of higher average energy than scintillation photons carried by the low-energy channel. Example embodiment including this feature include FIGS. 10, 14A, and 14B.

The one or more scintillator volumes may include a single scintillator volume that produces scintillation photons carried by both the low- and high-energy channels. FIG. 14B is one exemplification of this feature. Alternatively, the one or more scintillator volumes may include first and second scintillator volumes that produce scintillation photons carried by the low- and high-energy channels, respectively. FIG. 14A is one exemplification of this feature.

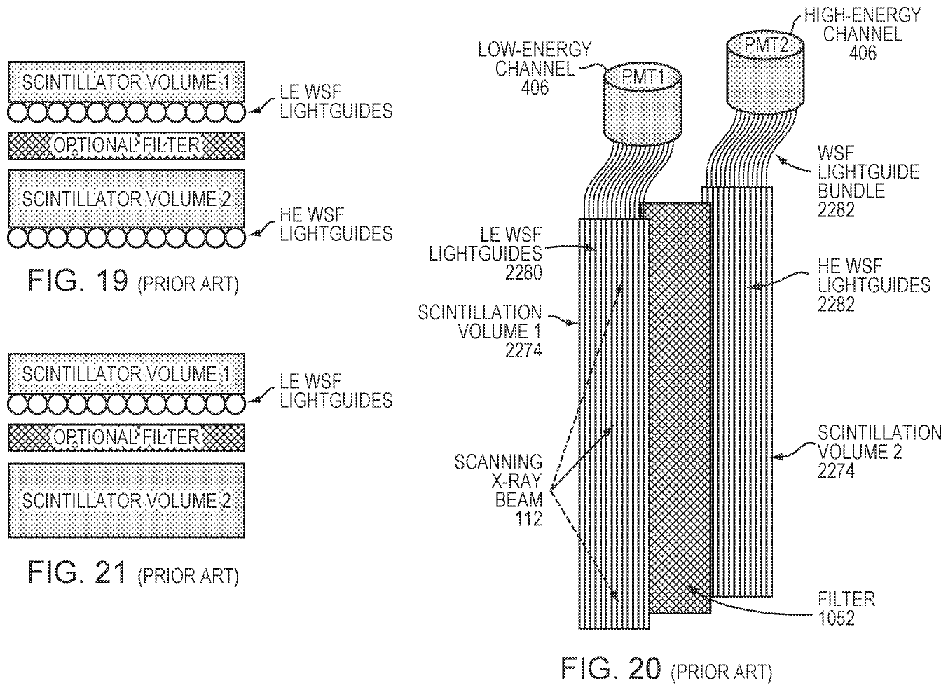

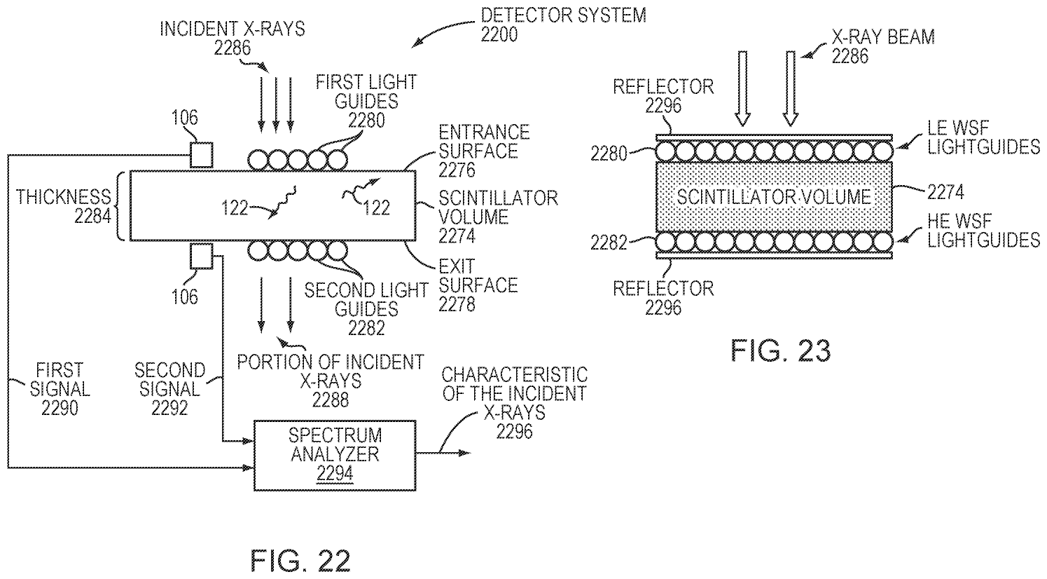

The first scintillator volume can be thinner than the second scintillator volume, and FIG. 22 illustrates what is meant by scintillator thickness. The first and second scintillator volumes, such as those illustrated in FIG. 14A, can include respective scintillator materials optimized for detecting relatively lower-energy and relatively higher-energy x-rays, respectively. An x-ray filter may be situated between the low-energy and high-energy channels, with the x-ray filter configured to filter out lower-energy x-rays, as illustrated in example FIGS. 19 and 20. Where an x-ray filter is used, it may be material comprising one or more elements selected from a group consisting of Cu, Sn, Mo, and W.

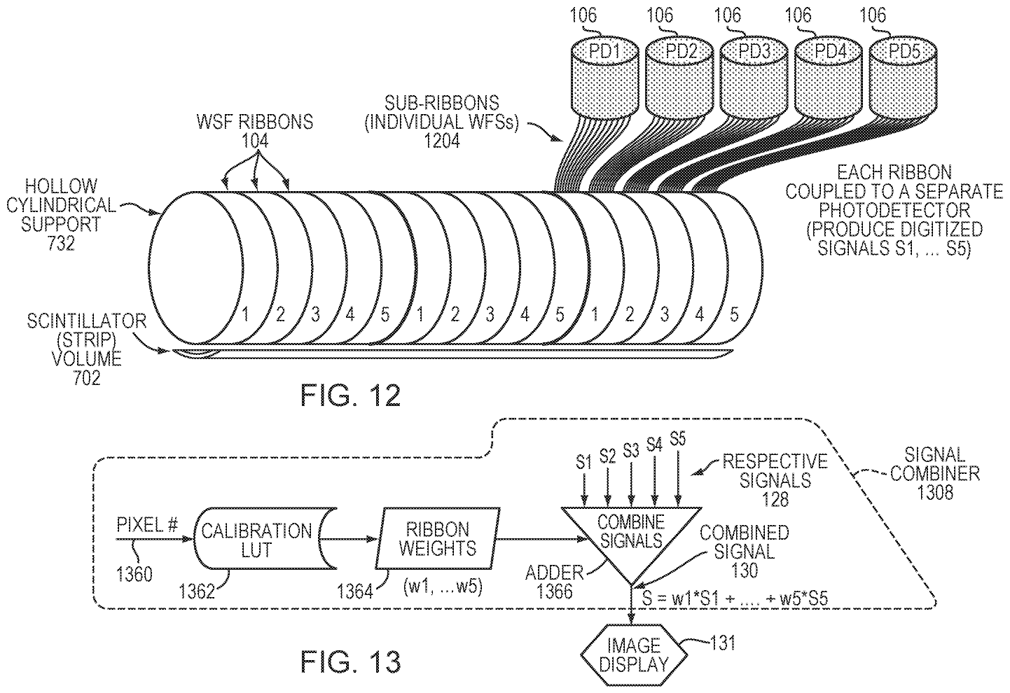

Each ribbon in a plurality of WSF ribbons, such as the ribbons 104 illustrated in FIGS. 1 and 7, may include only one WSF. Alternatively, each ribbon can include more than one WSF, as illustrated by the multiple sub-ribbons (individual WSFs) 1204 included in each WSF ribbon 104 in the embodiment of FIG. 12, for example. The plurality of ribbons in the detector system can be sub-ribbons of a master ribbon of WSFs. As an example, in the FIG. 12 embodiment, the five WSF ribbons 104 helically wrapped around the hollow cylindrical support 732 can be considered as five WSF sub-ribbons, and the set of five WSF sub-ribbons can be manufactured to be connected and parallel with each other, for example, and they can form a single master ribbon that is helically wrapped around the support structure 732.

The at least one respective photodetector coupled to an end of each respective ribbon, such as the photodetectors illustrated in example FIGS. 1 and 12, can be a photomultiplier tube (PMT). PMTs have the advantages of low dark current, as pointed out hereinabove. As illustrated in FIG. 12, each ribbon can include a plurality of sub-ribbons (individual WSFs). WSFs of each ribbon of a multi-fiber ribbon may be connected to only photodetector, or such WSFs may be optically coupled to respective photodetectors, such as respective anodes of a multi-anode PMT. For example, multi-anode PMTs are commonly available with 4-256 individual anodes, allowing 4-256 channels of input. The detector may be long enough to intercept the beam over an entire angle through which the beam is swept. Alternatively, the detector can be constructed out of shorter detector modules that are placed end-to-end to achieve full coverage of a swept beam. The at least one PMT described above may be an anode of a multi-anode PMT, and respective ribbons of the plurality of ribbons can optically coupled to respective anodes of the multi-anode PMT.

A scintillator material of the one or more scintillator volumes described above can include one or more materials selected from a group consisting of BaFCl, GOS, YOS, and ZnS.

Furthermore, in addition to embodiments specifically described herein, it will be apparent that other embodiments are included within the scope of the disclosure and claimed invention including various combinations of the elements of the specifically described embodiments. Moreover, it will become apparent that corresponding procedure for detection of a scanning beam of x-rays are also within the scope of embodiments, including using the detector system of any described embodiment or variation. It should be noted that an x-ray scanning beam with a substantially elliptical beam profile may be used to provide optimized imaging resolution in two orthogonal directions, and a detector system calibration may reflect such beam characteristic. Disclosed embodiment detector systems may also be adapted for use with an area detector suitable for scanning stationary objects.

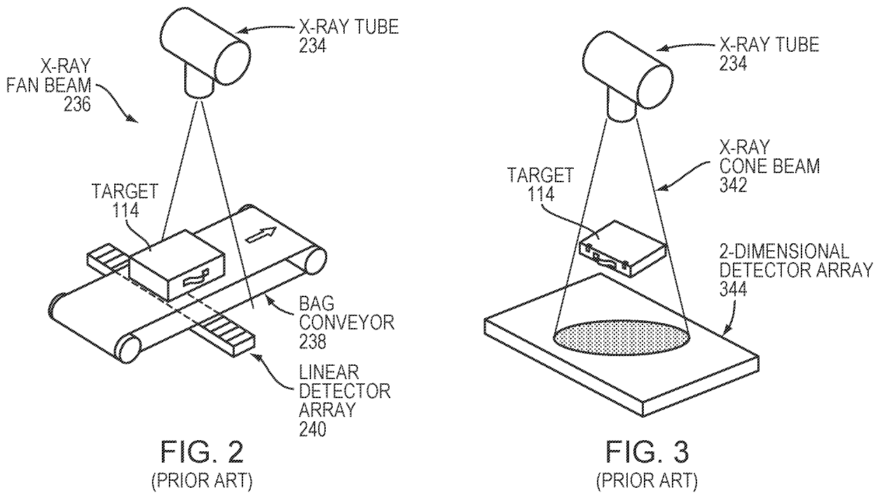

Prior art x-ray transmission detectors that are used for imaging systems utilize a fan beam (FIG. 2) or a cone beam (FIG. 3).

FIG. 2 (prior art) particularly shows an x-ray tube 234 outputting an x-ray fan beam 236 to a target 114 that travels along a bag conveyor 238. A linear detector array 240 is positioned on the opposing side of the conveyor 238. In the case of the fan beam, the x-ray image is created by the detector measuring the intensity of x-rays transmitted through the object and striking each segment along the length of the detector 240. This is often referred to as a “linear segmented detector array.” Typically, each segment or element of the linear array includes of a small piece of scintillator material that absorbs the x-rays and emits scintillation light, and the amount of light is then recorded by a solid state photodetector, such as a photodiode, optically coupled to the scintillator. The current from the photodiode corresponding to the light produced in each segment is digitized and corresponds to the intensity or brightness of one pixel in the image. The signal from all the detector elements in the linear array corresponds to one line of image pixels. By translating the object being imaged through the fan beam and acquiring a line of image data at many incremental positions during the translation, a full two-dimensional image of the object is acquired. Typically, several hundred lines of image data are acquired each second, with the acquisition of one line occurring in a few milliseconds.

FIG. 3 (prior art) is a perspective-view illustration of the x-ray tube 234 being used to create an x-ray cone beam 342 output toward a target 114. A two-dimensional detector array 344 is place on a side of the target 114 opposite the x-ray tube 234. In the case of imaging with a cone beam, the two-dimensional segmented detector array is used. For example, a flat panel detector used for very high-resolution imaging can include millions of square detector elements that are only 25 microns wide, yielding very high-resolution details in the image. In this case, only one acquisition is needed to acquire the full image, and no translation (of the object being imaged and/or the scanner) is required.

Because of the very large number of individual detector elements they contain, two-dimensional x-ray detectors (often referred to as “flat panel” detectors) such as the detector array 344 are very expensive. Because they contain photodiodes with a relatively high dark current, an integration time of a few milliseconds is typically required to produce an x-ray image with acceptable signal-to-noise characteristics. A shorter integration time produces images that are too noisy. Linear detector arrays (e.g., detector array 240 in FIG. 2) are less expensive but can still cost hundreds of dollars per inch of coverage, making large applications such as drive-through portals for vehicles very expensive. Since they typically also use photodiodes, they also require integration times of a few milliseconds.

In contrast to using a fan beam or cone beam of x-rays, backscatter imaging is achieved using a scanning pencil beam of x-rays. Unlike fan beam imaging, which creates an entire line of image data per acquisition period, backscatter imaging acquires one pixel at a time. Each point on the object being imaged is illuminated with the beam, and the intensity of the reflected x-rays is measured for each illumination point with large-area backscatter detectors. The intensity of the transmitted scanning beam can also be optionally measured, which is one subject of the current application. By raster-scanning the beam over the entire target object, a full two-dimensional image of the object can be obtained. Since an image line typically contains ˜1000 pixels, the integration time per pixel must be about a thousand times shorter than the integration time for fan beam imaging. It must therefore be on the order of microseconds, instead of milliseconds in duration. This then rules out the use of solid-state photodetectors, such as photodiodes, because as described above, they typically require millisecond integration times due to their high dark current. The only photodetector currently available with low enough noise levels for backscatter imaging with a scanning beam is a photomultiplier tube (PMT), which has a dark current measured in nanoamps—about a thousand times lower than most solid-state photodetectors. However, these devices are quite expensive (hundreds of dollars per device versus a few dollars for premium photodiodes), yielding unacceptably high costs for an array with many hundreds of detector elements. They are also relatively large—the smallest PMT on the market is 12 mm in diameter, making it impractical to use them in large linear detector arrays.

Since only PMTs will suffice for backscatter imaging with a scanning x-ray beam, and it is impractical due to cost and size reasons to create segmented linear arrays with PMTs as the photodetectors, a monolithic non-segmented scintillator volume optically coupled to one or more PMTs must be used. The disadvantage of this approach is that because there is no positional information in the transmission detector, the imaging resolution of the system is completely defined by the width of the x-ray beam at the object being imaged. The transmission detector is measuring the transmitted intensity of x-rays through the object at each position of the beam during its scanning motion. It should be apparent that the clarity or resolution of the object being imaged depends on the width of the beam at the object.

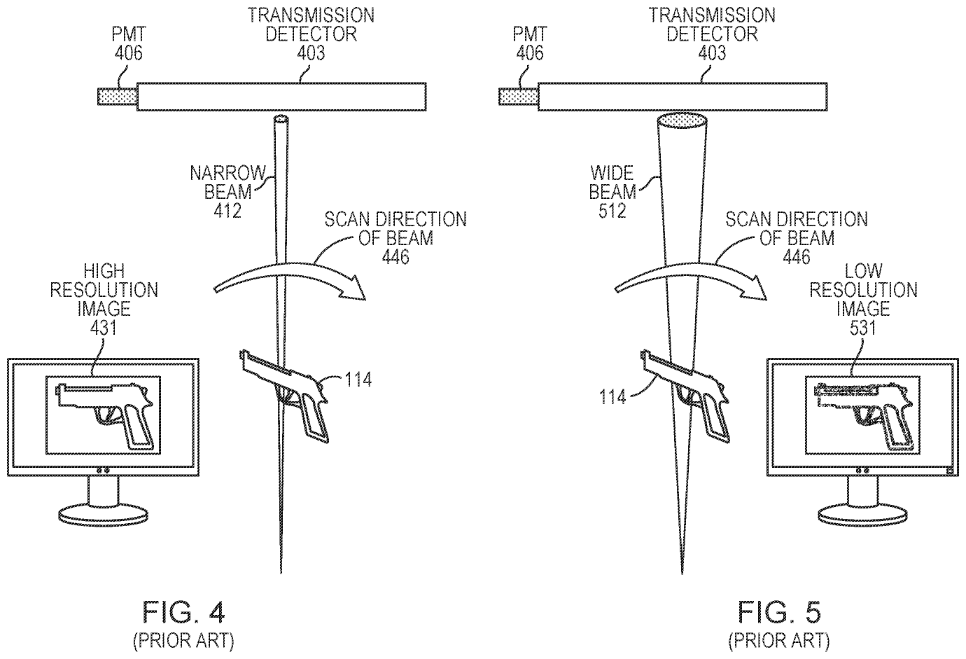

FIG. 4 (prior art) is a schematic illustration of a transmission detector 403 with a PMT 406 optically coupled thereto, both used in connection with a narrow x-ray beam 412 used for backscatter imaging of a target 114. The narrow pencil scanning beam 412 sweeps over the target 114 in a scan direction 446, and signals from the PMT 406 are used to create a high-resolution transmission image 431, in addition to any backscatter images that are obtained.

With the narrow beam 412 of FIG. 4, the edges of the target object 114 in the transmission image 431 are sharp because the transition from unattenuated to fully attenuated will occur in just a few pixels.

FIG. 5 (prior art) illustrates a scanning setup similar to that of FIG. 4, except using a wide x-ray pencil scanning beam 512. It is possible to make the wide beam 512 to be wide deliberately in order to increase signal at the transmission detector. In other cases, a narrow x-ray pencil beam simply becomes broader as it continues to diverge over time and distance from the x-ray source. A low-resolution image 531 results in this case. With a broad/wide x-ray scanning beam 512, the transition from unattenuated to fully attenuated is gradual, and the edges of the object will appear to be blurred in the image over many pixels.

One solution to this problem is to make the beam narrower as in FIG. 4. This presents issues, however, because making the collimating aperture that defines the beam to be smaller reduces the number of x-rays in the beam, and the signal-to-noise ratio of the image at some point becomes unacceptable. In addition, there is a fundamental limitation on how small the beam can be made due to the beam penumbra, which is a consequence of the focal spot of the x-ray source having a finite width. The focal spot size is a function of the x-ray source power and cannot be made arbitrarily small. The higher the power of the source, the larger the focal spot must be to distribute the heat load over the anode and not melt the anode material. For a 2 kW source, the focal spot with a tungsten anode is typically 1-2 mm in diameter. This means that if a collimating aperture with a diameter of 1 mm is 10 cm away from the focal spot, the beam at 3.5 m from the focal spot will have a width of 7-10.5 cm (2.8-4.1 inches).

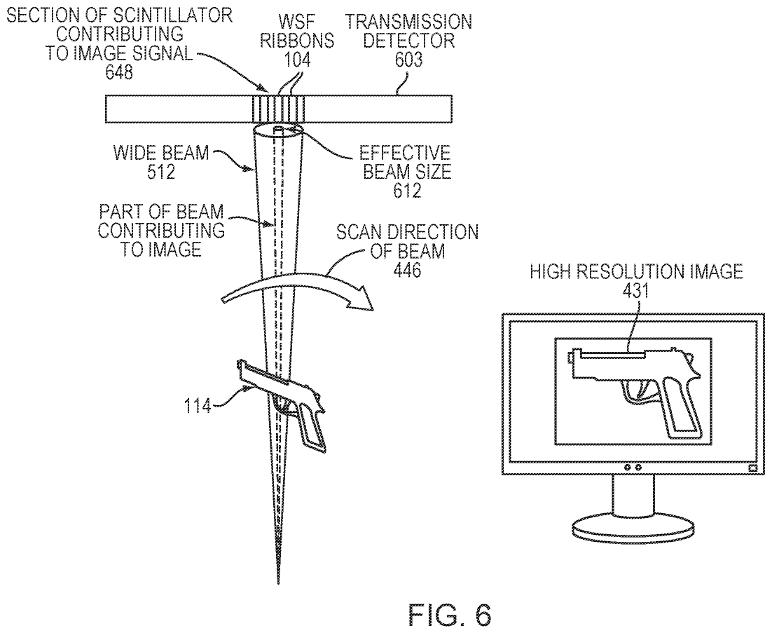

Embodiments consistent with the disclosure in this application use a novel means of reading out the scintillation light from a monolithic scintillator volume to provide transmission images of much higher resolution, even on a system that uses a wide scanning beam of x-rays as shown in FIG. 5. One aspect may be illustrated by comparison of the prior art system of FIG. 5 with a novel embodiment system shown in FIG. 6. In the FIG. 5 prior art transmission detector, the intensity of all the scintillation light produced in the scintillation material by the entire wide incident beam 512 is measured by the PMT 406. Since the signal from the entire beam 512 is being measured, the resolution of the resulting image 531 is poor because of the wide beam, as previously described.

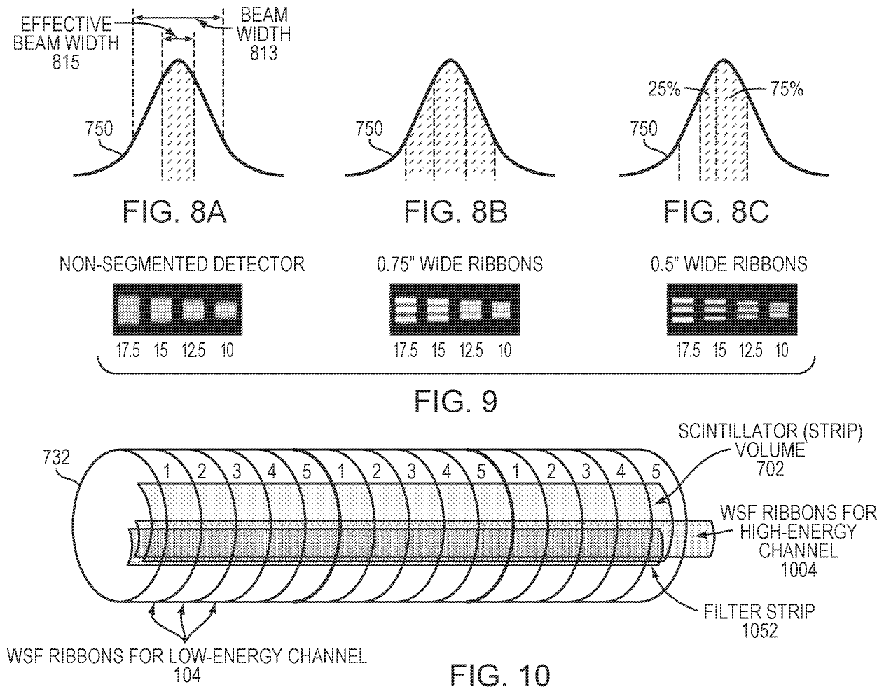

FIG. 6 shows a novel setup for improving the image resolution, in which the scintillation light from each linear section 604 of the detector, of a series of linear sections 104, along the scan direction of the incident beam, can be separately measured. For example, if the scintillation light can be read out separately for each section 604 (e.g., 1 cm wide) of a scintillator transmission detector 603, then an effective beam width producing that signal will be only 1 cm wide at the detector, and substantially narrower at the location of the object being imaged. For the previous example of a transmission detector 3.5 m from the focal spot, an effective beam size 612 is reduced, resulting in an effective beam profile width being reduced from 7-10 cm down to approximately 1 cm, resulting in an example factor of 7-10 increase in imaging resolution along the scan direction 446 of the beam. In other embodiments, imaging resolution may be increased by an example factor of at least 1.5, at least 2, at least 5, at least 7, at least 10, 1.5-15, 2-10, 2-8, 2-7, 2-5, 5-7, or 5-10, when compared with measuring signal from an entire scanning beam as in FIG. 5. Note that for scanning beam systems, the resolution along the direction transverse to the beam scan plane is not an issue, because it is fixed either by the width of the active area of the transmission detector or by using collimating plates. In the current example, either of these can be adjusted to ensure that the effective beam width in the transverse direction is also 1 cm, resulting in an effective resolution in the image of 1 cm along both image axes. In this manner, the high-resolution 431. Example full beam width and example effective beam width are illustrated further in FIG. 8A and may be measured at half beam intensity profile height, as in the full width at half maximum (FWHM) method, for example. Width of a given linear section 604 in FIG. 6 can define effective beam width of the beam portion having the illustrated effective beam size 612.

### Particular Single-Energy Embodiments

FIG. 7 is a schematic diagram of one single-energy embodiment x-ray detection structure 703 (also referred to herein as a “transmission detector”) that may be used in an embodiment x-ray detection system. In this embodiment, the transmission detector or x-ray detection structure 703 includes a hollow tubular (specifically, cylindrical) support structure 732 of a material (for example plastic or aluminum), a set of “WSF ribbons” 104, and a scintillator (strip) volume 702. The combination of the support 732 and WSF ribbons 104 without the scintillator volume 702 should be understood to constitute a “light detection structure” as that term is used herein. The x-ray detection structure 703 may form part of an embodiment x-ray detection system.

The support structure 732 has a curved outer surface 770. Around the surface 770, the set of WSF ribbons 104 of wavelength shifting fibers (WSF) are wrapped in a helical pattern that is illustrated more particularly in FIG. 15. Each ribbon 104 can include a series of parallel wavelength shifting fibers, which may have a diameter of between 0.5 mm and 3 mm, for example. A typical effective diameter is 1 mm. The ribbons 104 may include anywhere from 5 to 50 parallel fibers, as an example, and may be physically attached to each other via an adhesive material, or the fibers may be embedded in an optically transparent matrix. Alternatively, the ribbons 104 may each include a single WSF or 2-4 WSFs, for example. The ribbons 104 are wrapped in such a way as to repeat their order along the length of the support 732 of the detector. For example, the embodiment shown has five ribbons labeled 1 through 5.

A strip of scintillating material 702, which is an example of the scintillator volume 102 described in connection with FIG. 1, is optically coupled along its entire length with the underlying WSF ribbons, is positioned on the side of the detector facing the incident beam. x-rays absorbed in the scintillator will produce scintillation light, which will preferentially enter the ribbon of fibers directly below it at spatial periodic adjacencies similar to those illustrated in FIG. 1. Only a small fraction of the scintillation light will be able to enter a neighboring ribbon not directly under the point of absorption of the x-ray in the scintillator due to the high self-absorption of the scintillation light in the scintillation material, so there is no easy path for this cross talk to occur. Thus, scintillation light is predominantly and preferentially optically coupled only into WSF fibers at the spatial periodic adjacencies. Once the scintillation light enters a wavelength shifting fiber, it is absorbed and re-emitted in the fiber at a longer wavelength. It can therefore not be reabsorbed in the fiber, and between 5% and 7% of the light that enters the fiber is trapped within the fiber and transmitted to one of the two fiber ends (not illustrated in FIG. 7, but similar to the fiber ends 126 in FIG. 1). At least one end of each of the ribbons 104 is connected to a separate PMT, or alternatively, to a separate anode of a multi-anode PMT, allowing the light output of each of the ribbons to be independently measured for each integration period as the beam scans across the length of the detector.

Still referring to FIG. 7, since the x-ray intensity absorbed in the scintillator proximal to each ribbon can now be separately measured for each ribbon, different parts of the beam can now be selectively used to read from more, or less, of the beam profile. “Combining signals,” “signal combiner,” and similar terms as used in this application refer to the configuration to combine one or more of the different parts of the beam, as selected from signals for respective ribbons, for combinations to achieve the best results for a given application.

FIGS. 8A-8C are x-ray beam intensity profiles 750 showing various (shaded) portions of signal from the wide x-ray beam 512 that may be used for different applications. For example, for the highest resolution imaging, just a central part/section 648 of the wide x-ray beam profile 750 corresponding to a central WSF ribbon can be selectively used to form the image (see FIG. 8A). Alternatively, the output signals from additional ribbons on each side of the central ribbon can also be used to form the image (see FIG. 8B). This would be desirable, for example, if the penetration through steel of the imaging system is critical, in which case higher beam intensity is more important than resolution. Since the beam will often be positioned such that its centroid is proximal to a point between two ribbons, a weighting can be implemented in a signal combiner, wherein the signal from more than one ribbon may be used, as shown in FIG. 8C. In this example, 25% of the signal from the left ribbon is combined with 75% of the signal from the right ribbon to produce a combined signal used to create the image. FIG. 8A also shows a beam width 813 of the wide x-ray beam 512 (FWHM) and an effective beam width 815 that is obtained by using only the signal corresponding to ribbon 2 in FIG. 7, corresponding to the effective narrow x-ray beam 612 illustrated in FIG. 7.

### Detector Calibration

An initial calibration of an x-ray detector system, with no target objects in the beam, may be advantageously used to determine which ribbon signal (or combination of ribbon signals) should be used for each position of the scanning beam to achieve a scan objective. For example, if there are 1000 integration periods occurring during a single sweep of the beam across the detector (corresponding to 1000 pixels per image line), the software creating the image, such as a signal combiner according to various embodiments, may utilize a lookup table (LUT) such as that illustrated in FIG. 13 to assign a ribbon signal, or combination of signals, to form each pixel.

In the example of FIG. 8C given above in which two neighboring ribbon signals are combined in a weighted combination, for each pixel, the LUT would contain the two ribbon identifiers and the weighting to be applied to each. In other embodiments, a calibration process can include creating multiple LUTs. For example, one LUT can be used for the highest resolution mode for which signals from only one or two ribbons are combined, and another LUT can be used for the highest penetration, lowest resolution mode in which the signals from all the ribbons are used to create the image. Additional LUTs can be used for intermediate modes. It should be noted that an operator can be enabled to select the type of image that the operator would like to view in real-time and can be enabled to switch between the images at any time after the scan data has been acquired.

FIG. 9 shows simulated images from a computer simulation. A transmission image generated by a prior-art unsegmented transmission detector (FIG. 5) (left of FIG. 9) is compared with a detector using the setup shown in FIG. 8C with 0.75″ wide ribbons (center of FIG. 9) and 0.5″ wide ribbons (right of FIG. 9). The steady increase in image resolution can be seen from the left image to the right image. The phantom that was imaged in these simulations includes line-pair slots in a steel plate, with dimensions of 10 mm to 17.5 mm, as indicated in each of the left, middle, and right images of FIG. 9.

Note that the width and number of ribbons is preferably determined from the maximum width of the beam that is expected to be incident on the transmission detector. It is advantageous, but not essential, to have the number of ribbons, multiplied by the ribbon width, to be less than the maximum x-ray beam width to be measured. This will ensure that no ribbon is proximal to the beam at more than one location along the length of the detector.

### Certain Dual-Energy Embodiments

The embodiments described so far have been single-energy detectors, in which there is no spectral discrimination of the incoming beam. Many transmission imaging applications can benefit from some form of material discrimination. This is typically done using “sandwich” style scintillation detectors, in which a first scintillator volume is sensitive to the low-energy component of the x-ray beam and a second scintillation volume, placed so that it intercepts x-rays that have penetrated the first scintillation volume, is sensitive to the higher-energy component of the x-ray beam. Prior art examples are illustrated in FIGS. 19-21. Many of these detectors additionally place a low-energy filter between the two scintillation volumes to enhance a separation in energy to which the two detector channels are sensitive. This filter often includes a thin sheet of 0.25-2.0 mm thick copper, but other filter materials are also often used.

A sandwich style dual-energy detector has previously been used, with either both scintillation volumes read out with WSF, or with only the first scintillation volume intercepted by the beam read out with WSF. The approach taken with the dual-energy embodiments in this application is to use WSF to read out both low-energy and high-energy channels with WSF, but to not use a sandwich-style detector. This means that a given x-ray cannot traverse both scintillation volumes, but the volumes can be presented to the incident beam side-by-side.

FIG. 10 is a perspective-view illustration of one embodiment of such a dual-energy configuration x-ray detection structure. A single scintillator volume 702 in strip form is used for both a low-energy detector channel (a plurality of WSF ribbons) 104 and a high-energy channel (a WSF ribbon) 1004. A filter strip 1052 of filtering material, such as copper or tin, covers one half of the scintillator strip along the length of the detector. The filter strip 1052 allows preferentially the higher-energy x-rays in the x-ray beam to reach the underlying scintillator volume strip 702. The scintillation light from the filtered side of the scintillator strip (corresponding to the high-energy “HE” channel side of the scintillator) is read out with the single ribbon 1004 of multiple WSFs that runs along the length of the detector structure, and is positioned between the scintillator and the other set of WSF ribbons 104 (low-energy channel) that are wrapped around the support structure 732.

Further referring to FIG. 10, scintillation light from the unfiltered side of the scintillation strip (corresponding to the low-energy “LE” channel) is read out with the previously described repeating set of WSF ribbons, which are wrapped around the detector as shown. An optically opaque material between the LE channel ribbons and the HE channel ribbon may be used to help ensure that there is no optical coupling (and hence no crosstalk) between the two channels.

It will be clear to those of ordinary skill in the art that the particular, previously described, dual-energy detector embodiment of FIG. 10 provides higher-resolution imaging only in the LE channel, and not in the HE channel. While this may appear to be a limitation of the design, most imaging systems that provide material discrimination require the use of an averaging kernel in the algorithm in order to get the required statistics when assigning a material characteristic to a given image pixel. This means that the material characteristic assignment used to colorize the image is already at a significantly lower resolution than the underlying image, so an intrinsic lower resolution of the HE channel data is not expected to be a significant limitation.

Other embodiments using this side-by-side dual-energy detector setup can use more than one WSF ribbon running the length of the detector to read out the scintillation light from the HE channel. This could, for example, be used to increase the resolution of the high-energy channel along the direction transverse to the length of the detector. Still other embodiments can use separate strips of the same scintillator material for both channels to reduce any potential crosstalk between the channels. Alternatively, a further embodiment can use two strips of differing scintillation materials, with one designed to enhance the detection of low energy x-rays, and the other chosen to enhance the detection of higher-energy x-rays.

Those skilled in the art will understand that such a detector is able to provide the operator with material discrimination. x-rays transmitted though high-Z materials such as steel have fewer low-energy x-rays remaining in the beam than x-rays passing through organic materials, such as water or plastic. By analyzing the relative ratio of detector signals in the low- and high-energy channels, material discrimination can be performed. This is typically indicated to the operator by applying a color pallet to the image: orange for organic materials with low effective atomic number (Z), green for intermediate-Z materials such as Al, and blue for higher-Z materials such as steel.

Additional embodiments of the system can use an elliptical or rectangular beam profile (rather than a circular or square profile) that is elongated in the direction along the detector width or along the detector length. In this way, resolution can be further optimized in either direction without decreasing the cross-sectional area of the beam (and therefore the intensity of x-rays in it).

### Certain Embodiments for Scanning Stationary Objects

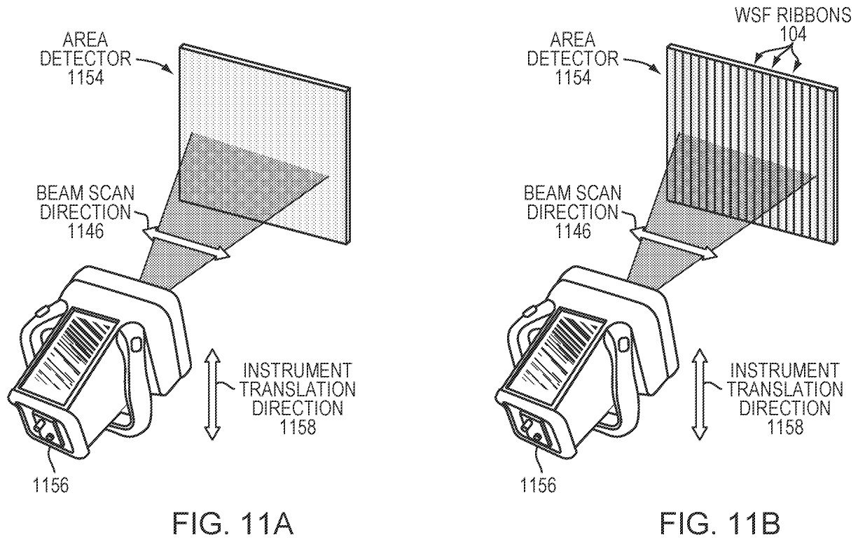

Handheld backscatter x-ray imaging instruments, such as the HBI-120 manufactured by Viken Detection Corp.™, can be used to scan, manually, stationary vehicles and objects such as abandoned parcels and bags. These instruments are typically used to create backscatter images of the object. However, by placing an unsegmented flat area detector behind the object, the intensity of the transmitted beam can also be measured, and a transmission image can be created. Unlike a scanning system in which the object is moved past or through the system, such as a baggage scanner with a conveyor or a drive-through portal for scanning vehicles, the handheld instrument typically images a stationary object. In this case, the instrument must be translated across the object during the scan. To acquire a transmission image with a line detector would require that the detector be translated simultaneously with the imaging system, which is usually not a practical possibility. Instead, a stationary area detector that is large enough to intercept the transmitted beam at all times during the scan is preferable, as shown in FIG. 11A.

FIG. 11A is a perspective-view diagram illustrating a handheld backscatter imager instrument 1156 outputting an x-ray pencil beam having a beam scan direction 1146. In this example, the instrument 1156 is moved in a vertical translation direction 1158 to scan a target object (not shown) that is positioned in front of the area detector 1154.

FIG. 11B is a perspective-view diagram illustrating the handheld instrument 1156 being used with a further embodiment area x-ray detector structure 1155. In this embodiment, the WSF ribbons 104 are placed in a repeating pattern across a width of the detector structure 1155, allowing the resolution along the scan direction of the sweeping beam to be increased. The image resolution along the instrument translation direction is intrinsically higher due to the presence of internal collimators that are used to define a tighter beam profile along this direction.

### Other Details of Embodiments

FIG. 12 is a schematic drawing illustrating respective photodetectors 106 optically coupled to respective WSF ribbons 104 that are wrapped around a hollow tubular (cylindrical) support structure 732 according to an embodiment. As illustrated in FIG. 12, each WSF ribbon 104 can be formed of multiple sub-ribbons (individual WSFs) 1204. In the embodiment of FIG. 12, all sub-ribbons 1204 in a given ribbon 104 are optically coupled to the same photodetector 106. However, in other embodiments, individual WSFs 1204 of a given multi-WSF ribbon 104 may be detected by a separate photodetector.

FIG. 13 is a block flow diagram illustrating an example signal combiner 1308 that may be used in embodiment x-ray detector systems. FIG. 13, as an example, assumes a set of five WSF ribbons 104, with five respective photodetector signals s1-s5 output from respective photodetectors 106, as in the embodiment of FIG. 12. At 1360, pixel numbers are designated to a calibration lookup table (LUT). Detector pixels consistent with various embodiments are described above. At 1362, the LUT outputs ribbon weights w1-w5 corresponding to given pixel numbers. At 1364, the ribbon weights are input to an adder 1366, which also accepts respective signals 128 (s1-s5) from the photodetectors 106 and combines the signals. The adder 1366 calculates and outputs a combined signal S 130 according to S=w1*s1_ . . . +w5*s5. The combined signal S 130 can be in a form representing a line scan, or multiple line scans, such that the combined signal S 130 can represent part or all of an image 131 that can be displayed to a user.

All or part of the signal combiner 1308 may run within a computer processor, embedded processor, or other processor. In a particular example, the LUT forms part of, and is stored in, computer memory or a type of non-volatile memory such as an EEPROM. The adder 1366 may include computer code that is executed in a computer processor, an embedded processor, or the like. In the example of FIG. 13, the signal combiner 1308 includes both the predefined LUT function and signal combination/adder function. However, in another embodiment, the signal combiner includes only the adder 1366, and either the LUT function is considered to be part of another component, or the combiner 1308 uses another means of combining the one or more signals.

Embodiment detector systems may further include a processor configured to create an image from the combined signal.

### Other Dual-Energy Embodiments

FIG. 14A is a cross-sectional diagram of an embodiment x-ray detection structure that takes advantage of helically wrapped WSF ribbons and provides dual-energy x-ray detection and discrimination, for detecting a scanning x-ray beam with enhanced spatial resolution, even when the scanning x-ray beam is relatively large. The x-ray detection structure of FIG. 14A includes the cylindrical support structure 732 illustrated in other embodiments. Around the cylindrical support structure 732 are wrapped a plurality of wavelength shifting fiber WSF ribbons 104 that are wrapped in helical fashion as previously described, and as described in further detail hereinafter in connection with FIG. 15. The plurality of WSF ribbons 104 constitute a low energy (LE) channel configured to detect, preferentially, lower energy x-rays. An LE scintillator volume 1402b covers a portion of the ribbons 104 and is configured to receive the x-rays from a portion, such as approximately half, of the wide x-ray beam scanning beam 512.

A high-energy (HE) filter 1052, in this case made of copper, is configured to receive x-rays from the other half of the x-ray beam 512, thus blocking preferentially lower energy x-rays from reaching a high-energy HD scintillator volume 1402a. A high-energy (HE) WSF ribbon 1004 is situated underneath the HE scintillator 1402a and is configured to interact with the higher energy x-rays to produce scintillation light. Via an optical coupling between the HE WSF ribbon 1004 and the HE scintillator 1402a, scintillation photons corresponding to the higher energy x-rays are optically coupled into the HE WSF ribbon 1004. An optically opaque layer 1468 situated between the HE WSF ribbon 1004 and the support cylinder 732 further assist in blocking scintillation photons resulting from higher energy x-rays from being coupled into the helically wrapped LE WSF ribbons 104.

In the manner illustrated in FIG. 14A, no detected x-rays from the incident beam 512 pass through both the LE scintillator volume 1402b and the HE scintillator volume 1402a. Furthermore, although not visible in the cross-sectional view of FIG. 14A, the HE filter 1052, HE scintillator 1402a, and HE WSF ribbon 1004 all extend a full length of the detector structure, similar to various components described in connection with FIG. 10.

FIG. 14B is a cross-sectional view diagram of an alternative dual-energy x-ray detection structure that may form part of various embodiments x-ray detection systems. The embodiment of FIG. 14B is similar in many respects to the embodiment of FIG. 14A, except that a shared scintillator volume 1502 is used for both high-energy and low-energy channels. Thus, the shared scintillator 1502 receives substantially all of the scanning x-ray beam 512, covering both low-energy and high-energy portions of the detector structure. On the low-energy (right) side, all x-rays, low-energy and high-energy, are allowed to interact with the shared scintillator volume 1502. Thus, scintillation photons produced by the low-energy side of the scintillator volume 1502 that result from both high-energy and low-energy x-rays may be optically coupled into the LE WSF ribbons 104.

On the other hand, on the left (HE) side of the x-ray detection structure, the HE filter 1052 passes preferentially higher energy x-rays from the left half of the x-ray beam 512. In this manner, scintillation photons produced by the left side of the shared scintillator 1502, which are optically coupled into the HE WSF ribbon 1004, predominantly result from higher energy x-rays. The x-ray detection structure of FIG. 14B also includes the optically opaque layer 1468, which assists in preventing scintillation photons produced on the left side of the shared scintillator 1502 from reaching the LE WSF ribbons 104. Although not visible from the cross-sectional view of FIG. 14B, the HE filter 1052, shared/common scintillator 1502, and HE WSF ribbon 1004 all extend a full length of the detector structure.

### Certain Embodiment Light Detection Structures and X-Ray Detection Structures

FIG. 15 is a side view illustration of a light detection structure 1500 according to an embodiment. The light detection structure 1500 includes a tubular support structure 1502 having a curved outer surface 770. The structure 1500 also includes a plurality of ribbons 104 of WSFs wrapped around the curved outer surface 770 in a spatially periodic, substantially helical pattern 1572. The plurality of ribbons of WSFs are configured to carry light to be detected at respective ends 126 of the plurality of ribbons 104. In some embodiments, detection occurs only at one end 126 of each of the plurality of ribbons 104. However, in other embodiments, light detection occurs at both ends of each WSF ribbon 104.

As will be understood by reference to other parts of this description, the light detection structure 1500 may form part of an x-ray detector and detection structure that includes a scintillator volume that interacts with x-rays to produce scintillation light that is optically coupled into the plurality of WSF ribbons 104. In turn, the x-ray detection structure may form part of an x-ray detection system as described in connection with FIG. 1 and other figures.

The tubular support structure 1502 in the particular light detection structure 1500 of FIG. 15 is formed of a scintillator material and forms a scintillator volume. In other embodiments, the single scintillator volume 1502 may be replaced by scintillator volume sections (i.e., multiple scintillator volumes that are configured to receive x-rays from an x-ray scanning beam. The scintillator volume 1502 is optically coupled to the plurality of ribbons 104, at least at locations of spatial periodic adjacency 124 of the ribbons 104 to a scanner axis 110 of a scan beam. Responsive to receiving x-rays from the x-ray scanning beam (not shown in FIG. 15), scintillation photons are produced by the scintillator volume 1502 and detected at at least one end 126 of each of the ribbons 104. In this manner, the light detection structure 1500, because it includes the scintillator volume/tubular support structure 1502, may also be considered and referred to herein as an x-ray detection structure.

It should be noted that scintillation photons comprising the light to be detected may be wavelength-shifted in the plurality of ribbons of WSFs. Both scintillation photons directly produced by the scintillator volume 1502, and wavelength-shifted scintillation light, are referred to herein as “scintillation photons,” “scintillation light,” “light to be detected,” and the like.

In other embodiments, the tubular support structure 1502 is not a scintillator volume, such that the light detection structure 1500 is not considered to be an x-ray detection structure. However, in certain embodiments, one or more scintillator volumes may be mechanically coupled to the tubular support structure 1502 and optically coupled to the plurality of WSF ribbons 104. The one or more scintillator volumes can be configured to receive x-rays and to produce scintillation photons responsively. The plurality of ribbons of WSF are configured to receive the scintillation photons and to convert the scintillation photons to the light to be detected. Thus, a separate scintillator volume is provided, separate from the support structure, as in various other figures.

In some embodiments, the separate scintillator volume may take the form of the strip scintillator volume 702 of FIG. 10, the LE scintillator 1402b or HE scintillator 1402a of FIG. 14A, or the shared scintillator 1502 of FIG. 14B, for example. Where a separate scintillator volume is provided as described, the light detection structure 1500, together with the scintillation volume, form an x-ray detection structure, which in turn, may form part of an x-ray detection system described in connection with FIG. 1 or other figures.

### Additional Dual-Energy Embodiments

Many transmission imaging applications have a requirement that there be some form of material discrimination. This is typically done using “sandwich”-style scintillation detectors, in which a first scintillator volume is sensitive to the low-energy component of the x-ray beam and a second scintillation volume, placed so that it intercepts x-rays that have penetrated the first scintillation volume, is sensitive to the higher-energy component of the x-ray beam. Many of these detectors additionally place a low-energy filter between the two scintillation volumes to enhance the separation in energy to which the two detector channels are sensitive. This filter often consists of a thin sheet of 0.25-2.0 mm thick copper, but other filter materials are often used.

FIG. 19 (prior art) and FIG. 20 (prior art) illustrate existing dual-energy x-ray detector structures. Existing systems use a sandwich-style dual-energy detector with two separate scintillation volumes, with either both scintillation volumes read out with WSF, as in FIG. 19 (prior art) and FIG. 20 (prior art), or with only the first scintillation volume intercepted by the beam read out with WSF and the second scintillation volume read out by some other means, as in FIG. 21 (prior art).

FIG. 20 (prior art) particularly shows a scanning x-ray beam 112 received at a sandwich-style detector including a scintillation volume 1 2274 having LE WSF light guides 2280 coupled thereto. The LE WSF light guides 2280 are read out by an LE channel PMT 1 406. Higher-energy x-rays that penetrate a filter 1052 situated between LE and HE channels are received by a scintillation volume 2 2274, which is optically couple to HE WSF light guides (WSF light guide bundle) 2282. The HE WSF light guides 2282 are read out by an HE channel PMT 2 406.

The approach taken with the embodiments in this application is to not use a sandwich-style detector containing two scintillation volumes, but to take advantage of one relatively thick scintillation volume for both low-energy and high-energy channels, and to read out each channel with WSF optically coupled to opposite sides of the relatively thick scintillator volume.

FIG. 22 is a schematic diagram illustrating an embodiment detector system 2204 determining a characteristic of an energy spectrum of x-rays. The detector system 2200 includes a scintillator volume 2274 having an entrance surface 2276 and an exit surface 2278. The entrance surface 2276 is configured to receive incident x-rays 2286. The incident x-rays 2286 may be from a scanning x-ray beam, also referred to herein as a sweeping x-ray beam, a stationary x-ray beam, such as a cone beam, or a fan beam, for example.

The scintillator volume 2274 is configured to emit scintillation light 122 responsive to receiving the incident x-rays 2286. The exit surface 2278 is configured to pass a portion of the incident x-rays 2286 that traverse a thickness 2284 of the scintillator volume 2274 between the entrance surface 2276 and the exit surface 2278.

The detector system 2200 further includes a first plurality of light guides 2280 that are optically coupled to the entrance surface 2276 of the scintillator volume 2274. The system 2200 also includes a second plurality of light guides 2282 that are optically coupled to the exit surface 2278 of the scintillator volume 2274.

The system includes at least one first photodetector 106 that is optically coupled to an end of the first light guides 2280. The first photodetector is configured to output a first signal 2290 responsive to the scintillation light 122 from the scintillator volume 2274. The system also includes at least one second photodetector 106 that is optically coupled to an end of the second plurality of light guides 2282 and is configured to output a second signal 2292 responsive to the scintillation light 122 from the scintillator volume 2274. Although ends of the first and second light guides are not specifically illustrated in FIG. 22, it should be understood what is meant by ends of the light guides by reference to FIG. 1, FIG. 15, and other drawings and corresponding descriptions herein.

The detector system 2200 further includes a spectrum analyzer 2294 that is configured to receive the first and second signals 2290, 2292 responsive to the scintillation light and to determine a characteristic of an energy spectrum a characteristic 2296 of an energy spectrum of the incident x-rays 2286 based on the first and second signals 2290, 2292.

The characteristic 2296 can include, for example, relative signal strength for at least two different wavelength segments of an energy spectrum of the incident x-rays 2286, for example. The characteristic 2296 alternatively can include an indication of a material or a material class of a target object through which the incident x-rays 2286 pass, or from which the incident x-rays 2286 are scattered. Identification of a material or material class of the target, or of other characteristics 2296 of incident x-rays incident on a dual energy x-ray detector, are known to those of skill in the art and are within the scope of this disclosure. However, such characteristics have not been previously determined with the benefit of a detector system such as the detector system 2200, which takes advantage of a single, common scintillator volume 2274 and relies on self-attenuation of scintillation light within the scintillator volume 2274 in order to achieve energy discrimination in the manner illustrated and described.

The spectrum analyzer may be a computer processor or an embedded processor or the like. It may output the characteristic of the energy spectrum, directly or indirectly, to a communication interface, a display, a printout, a human, etc.

The thickness of the scintillator volume can be larger than a self-attenuation length of a scintillator material of the scintillator volume. The scintillator volume can be a strip scintillator volume configured to receive the incident x-rays at the entrance surface thereof, from a sweeping x-ray beam transmitted through a target, over a sweep of the sweeping x-ray beam, such as the strip scintillator volume 702 of FIG. 7. The scintillator volume can be an area scintillator volume similar to the area detectors of FIGS. 11A-11B, for example. The scintillator volume may be configured to receive the incident x-rays at the entrance surface via x-ray scattering from a target. However, incident x-rays may alternatively be received at the entrance surface via passive emission from a target.

The first and second pluralities of light guides can be wavelength-shifting fibers (WSFs) or other light guides.

The scintillator volume can be in a tubular form, such as the form described in connection with FIG. 15, for example. The entrance and exit surfaces can be outer and inner curved surfaces, respectively, of a tubular wall of the scintillator volume if the volume defines an inner hollow portion. The first and second pluralities of light guides can be first and second pluralities of ribbons of WSFs, respectively, covering the outer and inner curved surfaces, respectively, of the tubular wall. The first plurality of ribbons can be wrapped around the outer curved surface in a spatially periodic, substantially helical pattern. The second plurality of ribbons can be inlaid around and adjacent to the inner curved surface in a repeating, spatially periodic, substantially helical pattern.

The at least one first photodetector and the at least one second photodetector can be photomultiplier tubes (PMTs). The at least one first photodetector and the at least one second photodetector can be separate anodes of at least one multi-anode PMT.

A scintillator material of the scintillator volume can include one or more materials selected from a group consisting of BaFCl, GOS, YOS, and ZnS.

FIG. 23 is a cross-sectional view of an advantageous embodiment configured specifically for x-ray transmission imaging. One volume of scintillator 2274 is advantageously used for both the low-energy detector channel 2280 and the high-energy channel 2282. The low-energy x-rays are preferentially absorbed closer to the entrance surface 2276 of the scintillator volume 2274, with the resulting scintillation light preferentially entering the layer of WSF 2280 optically coupled to the entrance surface 2274 of the scintillator volume. The higher-energy x-rays, which are more penetrating, will be absorbed, on average, deeper in the scintillator medium volume 2274, and the resulting scintillation light will preferentially enter the HE layer of WSF 2282 optically coupled to the exit surface 2278 of the scintillator volume 2274.

A reflector 2296 (top) assists to optically couple scintillation light produced by lower-energy x-rays by reflecting such light back toward the layer 2280. Similarly, a reflector 2296 (bottom) assists to optically couple scintillation light produced by higher-energy x-rays by reflecting such light back toward the layer 2282.

The energy discrimination characteristics of the detector system shown in FIG. 22, and the detector structures of FIGS. 23, 25, and 26, for example, can be optimized by carefully selecting the scintillator medium according to the following criteria:
Scintillator medium composition
Scintillator thickness
Scintillator optical attenuation

The scintillator medium and thickness can be carefully selected to ensure that the detection efficiency of the high-energy x-rays is high, while ensuring that the mean absorption depth of the x-rays in the low-energy and high-energy regions are well separated, providing good discrimination in the amount of scintillation light collected in the two independent WSF layers. This can be further enhanced by ensuring that the mean-free-path of the scintillation light in the scintillation medium is relatively short. This ensures that the light from the low-energy x-rays (absorbed near the entrance surface) has a low probability of being absorbed in the WSF layer on the exit surface, and conversely, that the light from the higher-energy x-rays (absorbed closer to the exit surface) has a lower probability of being absorbed in the WSF layer on the entrance surface.

A preferred scintillator medium that is relatively low cost and easy to incorporate mechanically into larger detectors is scintillating phosphor screen, such as BaFCl. This particular phosphor has a peak scintillation wavelength of about 390 nm, which is ideally matched to the peak absorption spectra of many types of WSF. It has a high detection efficiency for x-rays in the energy range of 25 keV to 225 keV and because of its crystalline structure, it has a relatively short mean-free-path of less than a millimeter for self-absorption of its own scintillation light, enhancing the separation in light collection between the two layers of WSF for low-energy versus high-energy x-rays.

By optimizing the thickness and optical light attenuation characteristics of the scintillator medium, a “dead” zone at the center of the scintillator volume can be established, for which scintillation light cannot reach either layer of WSF. The scintillator material in this center zone is therefore now acting effectively as the filter shown at the center of the prior-art detector in FIG. 19, as light from this region is not able to be detected at all. The only effect of this center material is to absorb or filter the higher energy x-rays that can pass into the high-energy region of the scintillator and contribute to the HE channel signal. This “dead” zone can therefore be optimized to further enhance the energy discrimination capability of the detector, much as the filter in FIG. 19 is designed to do.

Tests were performed with a 500 mg/cm2 thick volume of BaFCl phosphor screen as a scintillator volume sandwiched between two layers of WSFs. The phosphor screen had a transparent backing so that scintillation light could escape from both the entrance and exit surfaces of the scintillator. The light output of each WSF layer was recorded using an incident 140 kV x-ray beam, as different thicknesses of steel were introduced between the x-ray source and the detector.

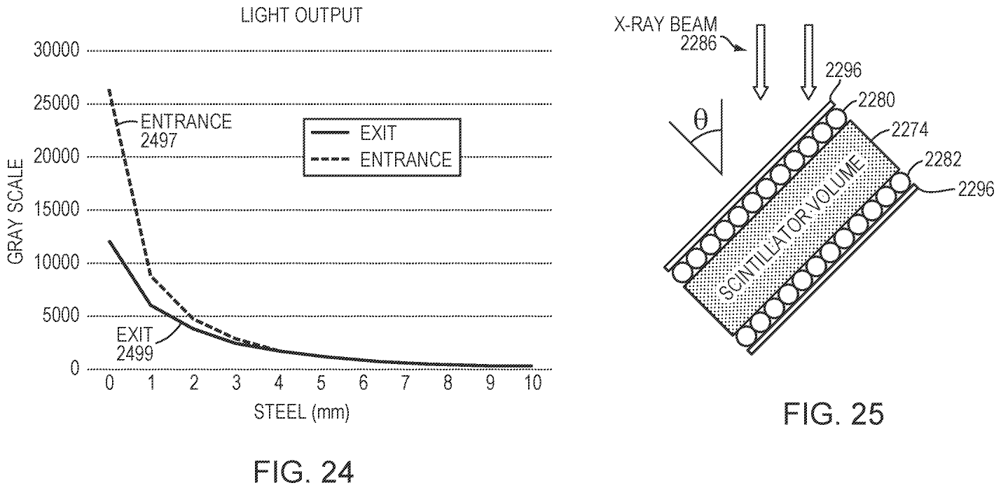

FIG. 24 is a graph illustrating results from the simulation. It can be seen that as more steel is added, the signal from the entrance WSF layer falls off much more rapidly than the signal from the exit WSF layer, indicating that the entrance layer WSF is preferentially detecting scintillation light from the lower-energy x-rays compared with the exit WSF layer.

Those skilled in the art will understand in view of this disclosure that such a detector is then able to provide the operator with material discrimination. X-rays transmitted though high-Z materials such as steel have fewer low-energy x-rays remaining in the beam than x-rays passing through organic materials, such as water or plastic. By analyzing the relative ratio of detector signals from the low and high energy channels, material discrimination can be performed. This is typically indicated to the operator by applying a color pallet to the image: orange for organic materials with low effective atomic number (Z), green for intermediate-Z materials such as Al, and blue for higher-Z materials such as steel. Thus, the characteristic 2296 of the incident x-rays described above may include the relative ratio of detector signals from the lower- and higher-energy channels, an indication of a likely material or material class of the target, or an indication such as a color display indicating a likely range of atomic number (Z) of a target, as indicated by analyzing energy of the incident x-rays.

Thickness of a scintillator volume may be further optimized as follows, and Table 1 will aid in the description.

TABLE 1

| | |
|---|---|
| MFP (mm) | 86% Areal Density (mg/cm2)* |

| keV | GdOS | BaFCl | GdOS | BaFCl |
|---|---|---|---|---|
| 50 | 0.1 | 0.4 | 21 | 32 |
| 120 | 0.9 | 3.0 | 158 | 248 |
| 140 | 1.3 | 4.4 | 233 | 361 |
| 160 | 1.9 | 5.9 | 321 | 492 |
| 220 | 3.8 | 11.5 | 657 | 948 |
| 600 | 16.4 | 39.0 | 2847 | 3233 |

*15 degree incidence angle

The first two columns of Table 1 above show the mean free path of x-rays of various energies in two different common scintillator screen materials. This is equivalent to the thickness required, assuming direct illumination (90 degree incidence angle), to stop 63% of the x-rays at the given energy.

The third and fourth columns of Table 1 show the areal density of scintillator screen needed to stop 63% of the incident x-rays, when the screen is angled at 15 degrees to the incident beam. Note that the lowest energy x-rays (E<50 keV) are absorbed within the first 0.1 and 0.4 mm of scintillator screen for GdOS and BaFCl, respectively.

If a low energy bin is defined as E(LE)<120 keV, then the low energy x-rays are mostly absorbed in the first 158 mg/cm2 and 248 mg/cm2 of the screen. If a 500 mg/cm2 thick screen is used, this will provide adequate separation between the low energy (E<120 keV) and higher energy (E>120 keV) x-rays.

FIG. 25 illustrates enhancement of detection efficiency by orienting the detector. For transmission imaging, the detection efficiency of the detector of FIG. 23 can be enhanced by orienting the detector scintillator volume 2274 so that it is illuminated obliquely by the incident x-ray beam 2286. This increases the effective length of the path that the incident x-ray beam must travel though the scintillator medium, increasing the probability of absorption of the x-rays in the medium, and increasing the probability of detection. Note that this requires no additional scintillator material, and therefore provides a very cost-effective way of improving detection efficiency. By orienting the entrance surface with a normal to the entrance surface at a non-zero angle θ with respect to the x-ray beam 2286, an effective thickness of the scintillator volume is increased by the factor 1/cos(θ). For example, by tilting the detector at a 750 angle to the incident beam, the detection efficiency of the scintillator is increased by almost a factor of four.

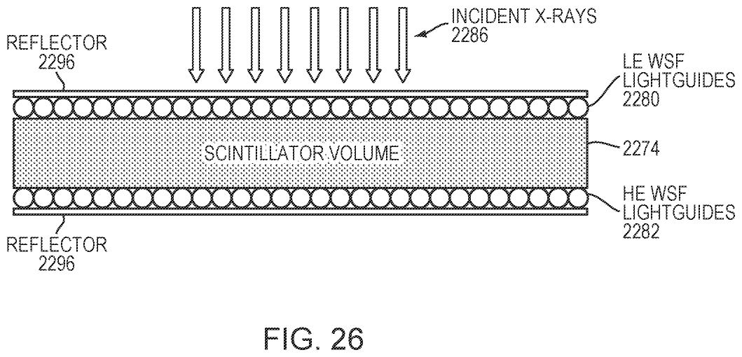

A further embodiment of the detector optimized for backscatter imaging is shown in FIG. 26. It is similar to the transmission detector configuration of FIG. 23, except that FIG. 26 is an area detector optimized for detecting diffuse scattered x-rays over a larger area rather than a strip detector optimized for detecting transmitted x-rays in an incident beam. In this configuration, the scintillator volume 2274 is formed of a sheet (or plate) of scintillator medium, and the layers of WSF 2280, 2282 consist of multiple ribbons placed side-by-side to one another.

### Increasing Detector Resolution of Dual-Energy Embodiments

Described herein in connection with FIGS. 1 and 6-18 are various embodiments of transmission detectors utilizing WSF that exhibit increased imaging resolution. Since the detector embodiments described in connection with FIGS. 22-26 can use similar ribbons of WSF in some embodiments, it will become apparent to those skilled in the art, in reference to this disclosure, that features described in connection with FIGS. 1 and 6-18 can be incorporated into embodiments described in connection with FIGS. 22-26, and vice-versa.

In some embodiments, various aspects of embodiments may be implemented in computers or software or firmware program products. In one example, lookup tables may be run in software or firmware. The computer program product(s) may be stored on a non-transitory computer readable medium that includes computer readable instructions that cause one or more processors to execute aspects of embodiment systems or related methods.

### Certain of the Present Embodiments Generally

One concept underlying the current embodiments may be understood by reference to FIGS. 6A-6B. The left figure (FIG. 6A) shows a prior art transmission detector in which the intensity of all the scintillation light produced in the scintillation material by the entire incident beam is measured by a photodetector. Since the signal from the entire beam is being measured, the resolution of the resulting image will be poor because of the wide beam, as discussed previously. The right of the figure (FIG. 6B) illustrates a novel method for improving the image resolution, in which the scintillation light from each linear section of the detector, along the scan direction of the incident beam, can be separately measured. For example, if the scintillation light can be read out separately for each 1 cm wide section of the scintillator, then the effective beam width producing that signal will be only 1 cm wide at the detector, and substantially narrower at the location of the object being imaged. For the previous example of a transmission detector 3.5 m from the focal spot, the effective beam width is reduced from 7-10 cm down to 1 cm, resulting in a factor of 7-10 increase in imaging resolution along the scan direction of the beam. Note that for scanning beam systems, the resolution along the direction transverse to the beam scan plane is not an issue, because it is fixed either by the width of the active area of the transmission detector or by using collimating plates. In the current example, either of these can be adjusted to ensure that the effective beam width in the transverse direction is also 1 cm, resulting in an effective resolution in the image of 1 cm along both image axes.

### Certain Single-Energy Embodiments of the Present Disclosure

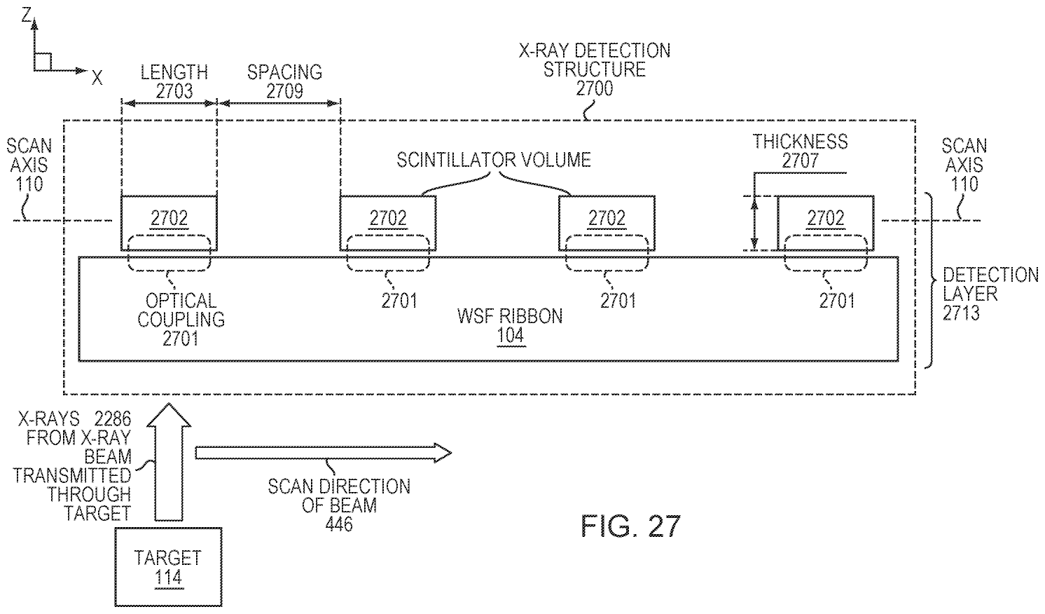

FIG. 27 is a schematic diagram showing a side view of an embodiment x-ray detection structure 2700. The structure 2700 includes a plurality of scintillator volumes 2702 in a spatially periodic arrangement. In particular, the scintillator volumes 2702 are spaced from each other by a spacing 2709 and form a scan axis 110 at which x-rays 2286 from an x-ray beam transmitted through a target 114 can be received. The plurality of scintillator volumes 2702 are configured to produce scintillation photons responsive to receiving the x-rays 2286.

The x-ray detection structure 2700 further includes a wavelength shifting fiber (WSF) ribbon optically coupled to the scintillator volumes 2702 along the scan axis 110. The WSF ribbon 104 is configured to receive scintillation photons from the plurality of scintillator volumes 2702 as the scanning beam of x-rays scans, resulting in the transmitted x-rays 2286, and causes at least a subset of the scintillator volumes 2702 in the scan axis 110 to produce the scintillation photons. While scintillation photons are not shown in the strong, example scintillation photons produced in a scintillator material are illustrated in FIG. 1 for complete understanding by those of skill in the art. As for complete understanding, it is noted that a sensor direction of the x-rays 2286 from the x-ray beam transmitted through the target 114 is considered to be parallel to the z-axis. A thickness 2707 of the scintillator volumes 2702 is measured, as illustrated, parallel to the Z direction. A length 2703 of the scintillator volumes 2702 is measured in the X direction, as illustrated.

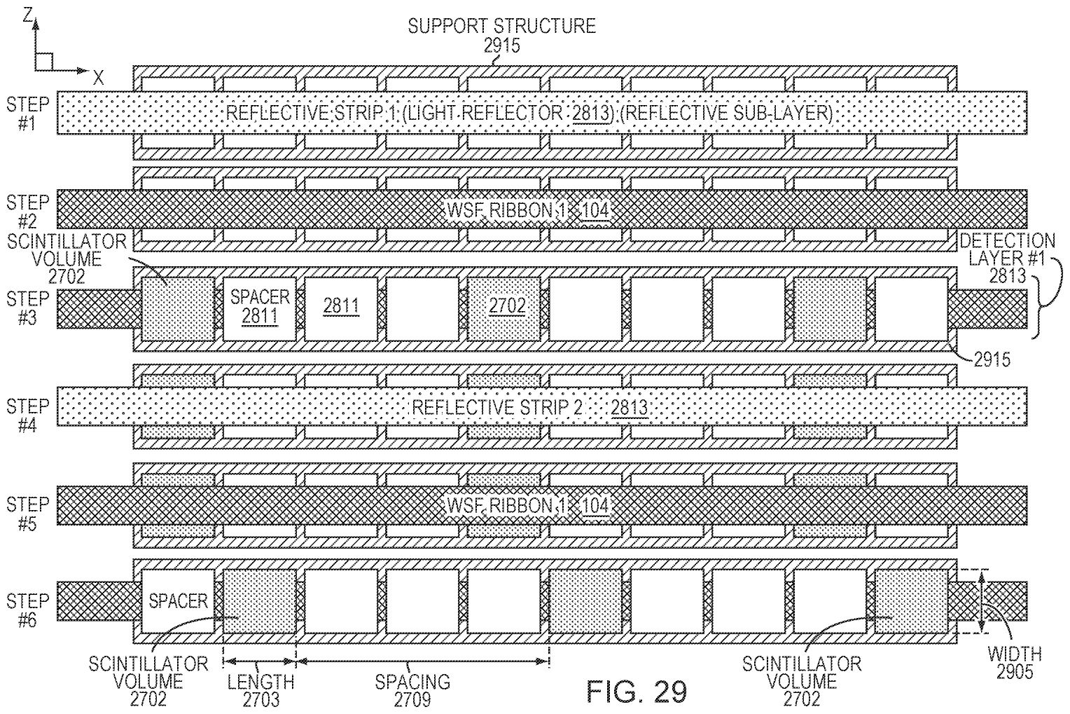

Further, while not shown in FIG. 27, example FIG. 29 does illustrate an example with 2905 of the scintillator volumes 2702, measured parallel to the y-axis. In certain advantageous embodiments, the with 2905 may be about 2.5 mm. Nonetheless, with 2905 in other embodiments can be, for example, on the order of 1 mm (e.g., 0.1 mm to 10 mm), on the order of 10 mm (between 1 mm and 100 mm), on the order of 2.5 mm, between one and 10 mm, or between two and 5 mm, for example. In one advantageous embodiment, the length 2703 can be 7 mm about 7 mm, for example. Nonetheless, the length can have any of the measurements or measurement ranges that the width can have, exemplified previously, or can be on the order of 7 mm, for example.

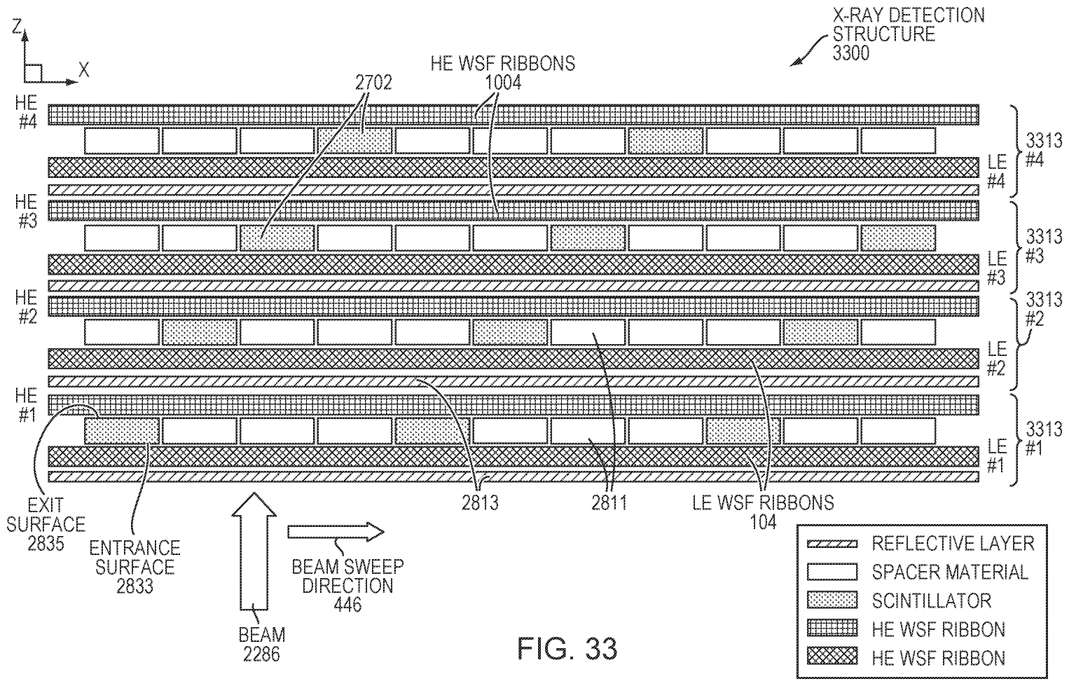

Further, in advantageous embodiments, the thickness 2707 can have any of the measurements or measurement ranges noted above for the length and the width, or can be about 4 mm thick, or on the order of 4 mm thick, in a range of 3-5 mm thick, or in a range of 2-7 mm thick, for example. In part, optimum thickness can depend on whether self-attenuation of scintillation photons is taken advantage of to achieve efficient dual-energy operation. An example of a dual energy embodiments is illustrated in FIG. 33, for example.

Furthermore, the dual energy embodiments described in connection with FIGS. 22-23, for example, can be advantageously applied to various of the present embodiments.

In dual energy embodiments, the thickness 2707 of the scintillator volumes can be, advantageously, larger than a self-attenuation length of the scintillation photons of a scintillator material from which the scintillator volumes are made. In some embodiments, the scintillator material of the plurality of scintillator volumes 2702 can be selected from one or more materials selected from a group of materials that consists of BaFCl, GOS, YOS, and ZnS. The scintillator volumes 2702 can comprise 500 mg/cm² BaFCl phosphor screen. The scintillator volumes 2702 can be laser-cut or water-jet-cut. Such manufacturing processes are particularly helpful in manufacturing various embodies them embodiments because of the vast number of scintillator volumes that can be used in various embodiments, enabling such embodiments to be practical by limiting cost of the scintillator materials.

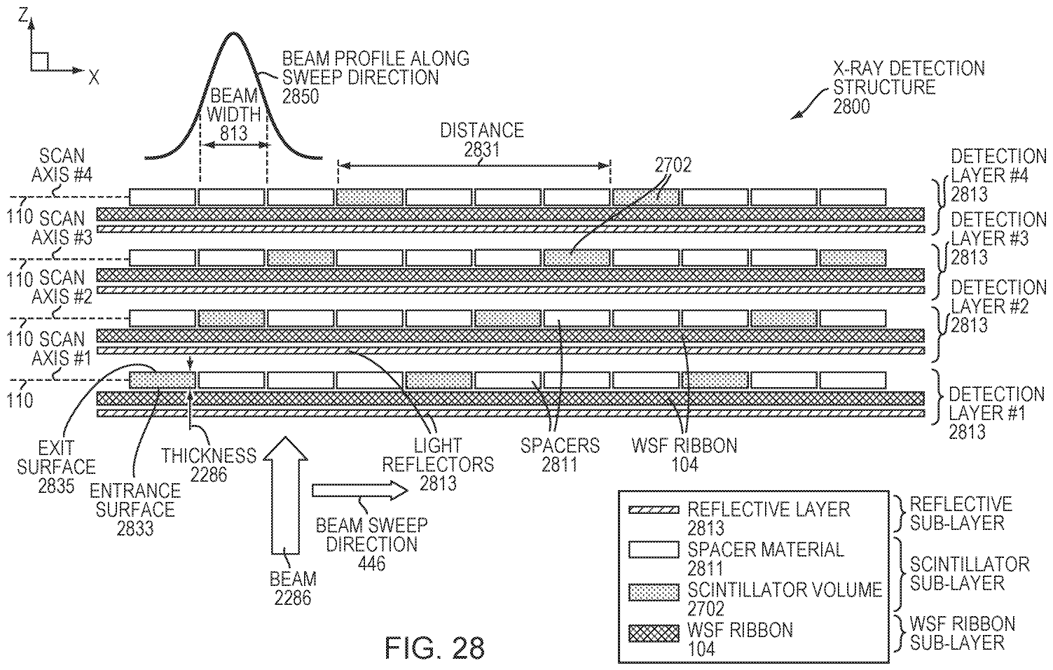

The spacing 2709 between the scintillator volumes 2702 is preferred to be close to a multiple of the length 2703, for reasons that will become clear hereinafter, such as in reference to FIGS. 28-29 and 33, for example. Such spacing allows for a plurality of spacers to be arranged in a spatially periodic arrangement in the scanner axis 110. The spacers, as illustrated in FIG. 28, for example, can be configured to transmit x-rays from the scanning beam 2286 that are incident on the spacers, allowing the spacers to transmit incident x-rays to successive detection layers. The spacers, such as the spacers 2811 illustrated hereinafter in reference to FIG. 28, are configured to be substantially transparent to the x-rays, but they can be opaque to scintillation photon wavelengths in order to increase optical isolation between different x-ray detection layers, as will become apparent by reference to FIGS. 12, 23, 28-29, and 33, for example.

Referring again to FIG. 27, where there are four detection layers, such as illustrated in FIG. 28, the spacing 2709 can be, for example, approximately three times the length 2703, allowing for three spacers or spacer with to be inserted between respective scintillator volumes 2702. Thus, one or more respective spacers can be situated between respective pairs of adjacent scintillator volumes 2702, such as the leftmost to scintillator volumes 2702 illustrated in FIG. 27, or the rightmost to scintillator volumes 2702 illustrated in FIG. 27, or the center to scintillator volumes 2702 illustrated in FIG. 27. This will become further apparent in reference to FIGS. 28-29 and 33, for example.

Light reflectors, also referred to with respect to the present embodiments as reflective layers or reflective sub-layers, can be advantageous for optical isolation of scintillation light between multiple x-ray detection layers. Examples are shown in FIGS. 28-29 and 33, for example the light reflectors can be mechanically fixed with respect to the WSF ribbon 104 and the plurality of scintillator volumes 2702 and configured to enhance receipt of the scintillation photons, emitted by the scintillator volumes 2702, by the WSF ribbon 104, thus enhancing optical coupling between the scintillator volumes and the WSF ribbon 104.

Furthermore, a support structure may be provided to which the plurality of scintillator volumes 2702 and the WSF ribbon 104 can be mechanically coupled, as illustrated in example FIG. 29.

Optical couplings 2701 are illustrated in FIG. 27 between the WSF ribbon 104 and the respective scintillator volumes 2702. As is understood by those of skill in the art, this coupling may be provided in part by the proximity between the WSF ribbon and the scintillator volumes, redirection of scintillation light by reflective layers, as already described, and as shown in FIG. 28, for example, or by other means known to those of skill in the art. As described herein above in connection with FIG. 1, and “scanner axis” is also referred to herein as a scanning axis, a scanner axis, and the like. In reference to the present embodiments particularly, a skin axis 110, such as that illustrated in FIG. 27, should be understood to be defined by a substantially linear arrangement of the scintillator volumes 2702 in a particular detection x-ray detection layer, such as that shown in FIG. 27, the detection layer 2713. Provided that the scintillator volumes 2702 in a particular detection layer 2713 are oriented sufficiently linearly so as to all be situated and optically coupled to a the same WSF ribbon 104 and have x-rays from a single sweep of a scanning x-ray pencil beam to be incident thereon with appropriate arrangements of the x-ray detection structure 2700 with respect to the scanning x-ray beam, the scanner axis 110 is, thus, defined by the substantially linear arrangement of the scintillator volumes, as illustrated in FIG. 27. Furthermore, it should be understood that a given, multi-layer x-ray detecting detection structure, such as those illustrated in FIGS. 28-29 and 33, for example, may have will have multiple scan axes, a respective scan axis corresponding to each x-ray detection layer in an embodiment x-ray detection structure that includes a linear or substantially linear array of periodically arranged scintillator volumes 2702.

Scintillator volumes 2702 can also be referred to herein with respect to the present embodiments as scintillator strips or scintillation strips. This is because, as illustrated in example FIG. 29, the length 2703 can differ from the width 2905, resulting in a rectangular or other non-square shape of the scintillator volumes. It will also be understood that dimensions of scintillator volumes may be particularly chosen in various embodiments in order to results in a desired resolution, signal-to-noise ratio, or other characteristics of an image that results from use of the embodiment x-ray detection structures and systems. These considerations have been described in connection with FIG. 9, for example, and it will be understood how to apply the principles to the present embodiments, as further illustrated and described in connection with FIGS. 8A-8C, FIG. 9, etc. and in reference to the present disclosure of the present embodiments.

In various embodiments, the number of scintillator volumes 2702 situated in linear array with respect to a single WSF ribbon 104 can be a number and that is greater than five, greater than or equal to 10, greater than or equal to 100, greater than or equal to 1000, greater than or equal to 10,000, between 1 and 100, between 10 and 1000, or between 10 and 10,000, or between 100 and 10,000, or on the order of 100 or on the order of 1000, for example. Furthermore, and may be greater than 10,000. depending on the requirements of requirements of a particular application and embodiment with respect to resolution, speed of scan, characteristics of an x-ray scanner providing the x-ray beam, such as beam size, etc.

FIG. 28 is a side view of an example embodiment x-ray detection structure 2800 having for detection layers with four respective scintillator sub-layers and four respective WSF ribbon sub-layers, with other elements. The structure 2800 has detection layers 2813 number one, number two, number three, and number four for a total of four detection layers. Each detection layer has a respective scintillation sublayer having a respective plurality of scintillation volumes 2702, as well as for respective WSF ribbon 104, which are also referred to herein as WSF ribbon the sub layers.

The x-ray detection structure 2800 also includes light reflectors 2813 positioned within each detection layer 2813. Spacers 2811 are situated and arranged, as already described herein above, in spaces between the scintillation volumes 2702. Accordingly, x-ray detection layer number one includes a scan axis 110 #1, and each respective detection layer has a respective scan axis 110.

As used herein, where spacers are “in” the scanner axis, this should be understood to mean that they are situated only sufficiently aligned with the scintillator volumes 2702 2702 in order to maintain spacing between the scintillator volumes 2702 and pass x-rays to subsequent layers and assist in scintillation light isolation between the respective layers. Within those parameters, the spacers are considered to be “in” their respective scan axes 110.

As already noted hereinabove, each of the respective x-ray detection layers 2813 includes a respective light reflector (reflective sub-layer) 2013. Each of the scintillator volumes 2702 has a thickness 2286, potential parameters for which have been described hereinabove. Also illustrated in FIG. 28 is an example beam profile 2854 x-rays of the scanning beam 2286 in the X direction, which is parallel to the beam sleep direction 446. The beam profile 2850 has a beam width 813, which may be evaluated, measured, or otherwise designated by various types of beam width parameters, such as full width at half Max. In part, the beam width 813 will determine constraints on length of the scintillator volumes 2702, and, consequently, the spacers 2011.

It is desirable for the beam with 813 to be no larger than a distance 2831 from an edge of one of the scintillator volumes to a corresponding edge of the adjacent scintillator volume, as illustrated by the distance 2831 in FIG. 28. In this manner, aliasing can be avoided. It will be understood that it is desirable for the x-rays 2286 having the profile 2850 to be detected by only one of the scintillator volumes 2702 in each detection layer 2013 at any given sleep position of the beam 2286 along the sleep direction 446. Thus, it is desirable for the length of the scintillator volumes 2702 in the X direction to be chosen such that, when the X direction positions of the scintillator volumes 2702 are staggered in the X direction as shown, the beam width does not extend beyond a set of scintillator volumes 2702 in respective detection layers that are adjacent to one another considered along the X direction.

It will be understood that the beam profile 2850 may be wide, like the beam profile 750 described herein above, but effectively narrower, such as the effective beam with 815 described above, due to the periodic structure of the detection layers and scintillator volumes and spacers therein.

At the leftmost scintillator volume 2702 in layer #1, of FIG. 28, x-ray radiation interacts with the x-ray scintillator volume 2702 in the detection layer #1. In the second left-most position, a spacer 2811 in the detection layer #1 is transparent to the x-rays 2286 and passes them on to the vertically corresponding scintillator volume 2011 in the detection layer #2. In this manner, as the beam 2286 sweeps in the direction 446, the x-rays are passed to successive detection layers, up to detection layer #4 in the fourth left-most position, and finally, the beam 2286 again and counters a scintillator volume in detection layer #1.

Given the structure that is illustrated in FIG. 28, it will be understood that embodiment x-ray detection structures can include each of the scintillator volumes 2702 having an entrance surface 2833 where the x-ray beam 2286 first encounters the scintillator volume, and an exit surface 2835, where the x-ray beam last encounters the particular scintillator volume. Thus, the entrance surface is configured to receive incident x-rays from the scanning beam transmitted through the target, and the exit surface is configured to pass a portion of the incident x-rays the traverse a thickness 2707 of the respective scintillator volume between the entrance surface and the exit surface thereof.

As will be illustrated further hereinafter in connection with FIG. 33, the WSF ribbon can be a first WSF ribbon optically and coupled to the entrance surface 2833 of the scintillator volumes in a particular detection layer, and each detection layer can further include a second WSF ribbon optically coupled to the exit surface 2035 of the scintillator volumes in that detection layer. These first and second WSF ribbons can be used to detect scintillation light resulting from, preferentially, low energy and high-energy x-rays, or lower energy, and relatively higher energy x-rays, such that the first and second ribbons may be referred to as an LE WSF ribbon 104 and an HE WSF ribbon 1004, as illustrated in FIG. 33.

Referring again to FIG. 28, it will be understood from the structure that is shown and described that the plurality of scintillator volumes can be a first plurality of scintillator volumes, the WSF ribbon can be a first WSF ribbon, and the scan axis can be a first scan axis, all these items pertaining to, for example, the first x-ray detection layer. The detection structure, as shown in FIG. 28, can further include a plurality of detection layers, such as the four shown in FIG. 28. A first detection layer of the plurality of detection layers includes the first plurality of scintillator volumes and the first WSF ribbon.

Further, respective detection layers of the plurality of detection layers include respective pluralities of scintillator volumes in respective spatially periodic arrangements, spaced from each other and forming respective scan axes 110 of the scanning beam of x-rays 2286 at which the x-rays from the scanning beams that are transmitted through the target can be received. The respective pluralities of scintillator volumes can further be configured to produce respective scintillation photons responsive to receiving the x-rays, as already described. The respective layers of the plurality of layers 2813 #1-#4 can further include respective WSF ribbons optically coupled to respective pluralities of scintillator volumes along respective scan axes, respective WSF ribbons configured to receive respective scintillation photons from respective pluralities of scintillator volumes as the scanning beam of x-rays 2286 scans and causes at least respective subsets of the respective pluralities of scintillator volumes in the respective scan axes to produce the scintillation photons

As will also be apparent from FIG. 28, in an x-ray detecting detection structures such as the structure 2800, each respective layer can further include a plurality of spacers 2011 in spatially periodic arrangement in the respective scan axis, the spacers configured to transmit x-rays from the scanning beam transmitted through the target, one or more respective spacers of the plurality of spacers situated between respective pairs of adjacent scintillator volumes of the plurality of scintillator volumes of the respective layer, where the spacers are substantially transparent to the x-rays 2286.

Furthermore, it will be understood in reference to FIG. 28 that each scintillator volume of a respective plurality of scintillator volumes of a respective layer is offset, along a direction of the scan axis 110, from all other scintillator volumes of other layers of the plurality of layers.

It should be understood that the “spacers” in embodiments of the present application are always transparent to x-rays, as they should be configured to pass the x-rays to successive detection layers for traversal in a scintillation volume and detection of the corresponding scintillation light. It will also be understood that the spacers in the present embodiment do not produce scintillation photons. Where the present description refers to “opaque” spacers, the opacity of the spacers is in the wavelength range of the scintillation light.

As a further description of FIG. 28, a schematic diagram showing a side-view of a single-energy embodiment is shown therein. In this embodiment, the detection structure 2800, which may be advantageously used for transmission detection, includes four layers of scintillator strips (preferentially including scintillating phosphor screen) arranged in an alternating manner, so that the incident x-ray beam, regardless of position, will illuminate one scintillator strip in at least one of the four layers. It should be noted that this is for illustrative purposes only, and typically more layers will be used. In the figure, the beam centroid is incident mostly on a strip in layer #2, with some of the x-rays in the tails of the beam illuminating strips in layer #1 and layer #3. By selectively only using the scintillator signal from a subset of the layers, the effective width of the illuminating beam that is used to form the image is reduced, increasing the resolution of the resulting image. Note that for this arrangement to work best, the beam preferably should not be wider than the separation between the scintillator strips in any layer. If this is not the case, then it is possible for image artifacts to start to appear, as the profile of the detected beam can effectively become bimodal (equivalent to twin beams).

The scintillation light from all the strips located in a particular detection layer can be read out with a single linear WSF ribbon, running the length of the detector. The ribbon for each layer of strips is preferentially optically coupled to the side of the scintillator strips on which the beam is incident, as this allows the light from lower-energy x-rays absorbed near the surface of the scintillator to be detected, with little intervening scintillator material between the absorption point and the fiber that can self-absorb the light. The higher energy x-rays are typically absorbed deeper in the scintillator but will produce more scintillation light, which can compensate for the larger amounts of self-absorption occurring before the light enters the WSF ribbon.

Once the scintillation light enters a wavelength shifting fiber, it is absorbed and re-emitted in the fiber at a longer wavelength. It is therefore not reabsorbed in the fiber, and between 5% and 7% of the light that enters the fiber is trapped within the fiber and transmitted to one of the two fiber ends. At least one end of each ribbon optically coupled to each layer of strips is connected to a separate photodetector such as a PMT, or alternatively, to a separate anode of a multi-anode PMT, allowing the light output of each of the ribbons to be independently measured for each integration period as the beam scans across the length of the detector.

An example embodiment of the light detection structure may be seen in in layer #1 in FIG. 28, which can optionally include a reflective sub-layer and opaque spacer materials as illustrated.

The light detection structure can include the following variation: The plurality of scintillator volumes can be a first plurality of scintillator volumes, the WSF ribbon can be a first WSF ribbon, and the scan axis can be a first scan axis. The light detection structure can further include a plurality of layers, a first layer of the plurality of layers including the first plurality of scintillator volumes and the first WSF ribbon; and respective layers of the plurality of layers including respective pluralities of scintillator volumes configured to be oriented spaced from each other and in the spatially periodic form along respective scan axes of the scanning beam of x-rays to receive x-rays from the scanning beam transmitted through the target, the respective pluralities of scintillator volumes further configured to produce respective scintillation photons responsive to receiving the x-rays; and the respective layers of the plurality of layers further including respective WSF ribbons optically coupled to respective scintillator volumes of the pluralities of scintillator volumes along the respective scan axes, respective WSF ribbons configured to receive respective scintillation photons from respective pluralities of scintillator volumes of the plurality of scintillator volumes via the respective optical couplings as the scanning beam of x-rays scans over the respective scan axes.

An example embodiment of the above variation may be viewed in reference to the four layers illustrated in FIG. 28.

FIG. 29 is a top view of the x-ray detection structure of FIG. 28, at various example stages or steps of assembly or manufacture. The detection structure 2800, shown in stages of construction, includes a support structure 2915 that holds all the scintillator strips and WSF ribbons in place. This can, for example, include 3D-printed plastic modules that are held together in an aluminum housing.

A first stage includes placing an optically reflective strip at the bottom of the support structure. In a second step (stage of manufacturing/assembling), a WSF ribbon is placed to form the readout of layer #1. In a third stage, an alternating pattern of scintillator strips and opaque spacers is inserted to form the first detection layer. In a fourth stage, another reflective strip is placed to provide optical isolation. In a fifth stage, a second WSF ribbon is placed to provide readout for the second layer. In a sixth stage, the scintillator strips for the second layer are put in position, with the sequence of scintillator strips and spacers shifted to the left by one position.

The fourth, fifth, and sixth steps can then be repeated to build up the entire multi-layer detector structure with all of the relevant layers. For example, a preferred embodiment can include six layers of ⅓ inch wide strips of 500 mg BaFCl scintillator screen, with the center-to-center separation of the strips in each layer being approximately 2 inches, and the length of the strips being approximately one inch. Six individual PMTs are coupled to at least one end of each of the WSF ribbons. The distal end of the ribbons can be coated with a reflective material or can be attached to another set of PMTs. Alternatively, if only one PMT is used per ribbon, the ribbons can be designed to have a loop at the end distal to the PMT, with the same fibers looping back along the length of the layer, allowing both ends of the fibers within the ribbon to be coupled to a single PMT. Another embodiment can use one (or two) multi-anode PMTs to measure the light output of one (or both) ends of the ribbons, rather than using multiple individual PMTs.

It will be noted that FIGS. 8A-8C show illustrations of several different manners for combining the signals from the WSF ribbons in FIG. 6 to achieve varying degrees of image resolution and/or penetration. While FIGS. 8A-8C are in reference to the embodiments of the previous noted PCT application, similar signal combination principles apply to the present embodiments. Since the X-ray intensity absorbed in the scintillator strip coupled to each ribbon can now be separately measured for each layer, different parts of the beam can be selectively used to utilize more, or less, of the beam profile. For example, for the highest resolution imaging, just the layer corresponding to the centroid of the beam can be used to form the image (see FIG. 8A). Alternatively, the output signals from additional layers corresponding to strips illuminated by the tails of the beam can also be used to form the image (FIG. 8B). This would be desirable, for example, if the penetration through steel of the imaging system is critical, in which case higher beam intensity is more important than resolution. Since the beam will often be positioned so that its centroid is proximal to a point between strips lying in two different layers, a weighting method can be used that selectively uses the signal from more than one layer, as shown in FIG. 8C. In this example, 25% of the signal from a layer containing a strip illuminated by the left of the beam is combined with 75% of the signal from a layer containing a strip illuminated by the right of the beam, to produce a combined signal used to create the image.

### Certain of the Present Embodiments for Scanning Stationary Objects

Handheld backscatter X-ray imaging instruments, such as the HBI-120 manufactured by Viken Detection™ Corp., are used to manually scan stationary vehicles and objects such as abandoned parcels and bags. These instruments are typically used to create backscatter images of the object. However, by placing an unsegmented (monolithic) area panel detector behind the object, the intensity of the transmitted beam can also be measured, and a transmission image can be created. Unlike a scanning system in which the object is moved past or through the system, such as a baggage scanner with a conveyor or a drive-through portal for scanning vehicles, the handheld instrument typically images a stationary object. In this case, the instrument must be translated across the object during the scan. To acquire a transmission image with a line detector would require that the detector be translated simultaneously with the imaging system, which is not always a practical possibility. Instead, a stationary area detector which is large enough to intercept the transmitted beam at all times during the scan is used, as shown in FIG. 11A. In this example, the instrument is moved in the vertical direction to scan an object (not shown) that is positioned in front of the area detector.

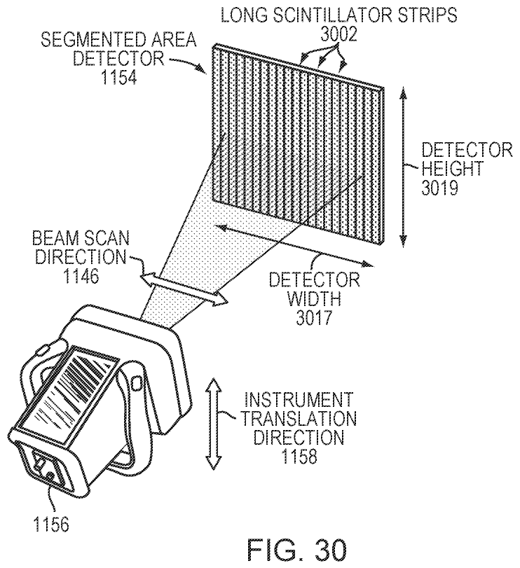

FIG. 30 is a perspective view of an existing handheld x-ray imaging system similar to that of FIGS. 11A-11B, except used in an embodiment system with an embodiment x-ray detection structure adapted for use as an area detector for high resolution transmission imaging. The FIG. 30 embodiment is adapted for use with an area transmission detector 3054. In this embodiment, the scintillator strips 3002 have a length equal to the height 3019 of the area detector and are placed in a repeating pattern across the width 3017 of the detector, allowing the resolution along the scan direction 1146 of the sweeping beam to be increased. The image resolution along the instrument translation direction is intrinsically higher due to the presence of internal collimators that are used to define a tighter beam profile along this direction.

### Detector Calibration in Certain of the Present Embodiments

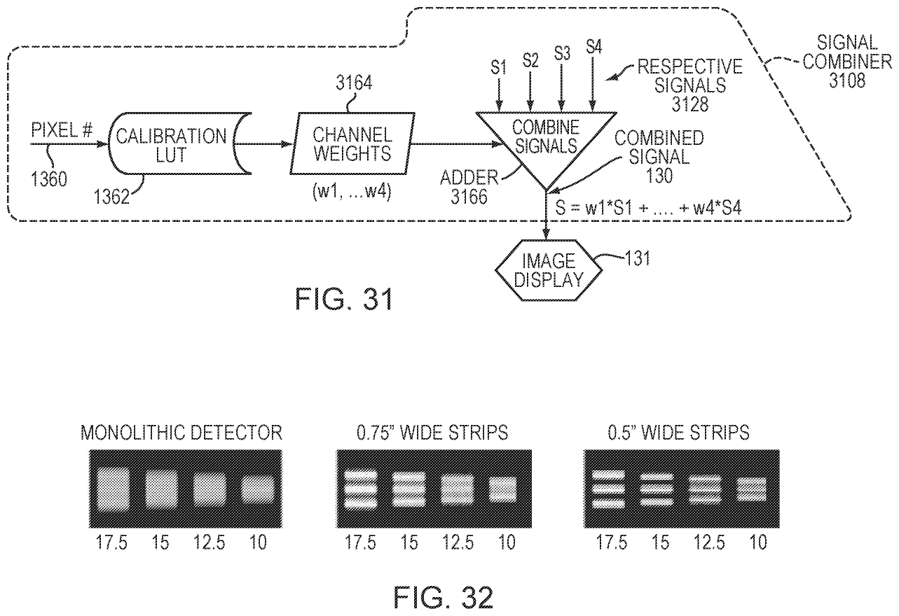

FIG. 31 is a schematic diagram of a signal combiner 3108 that can be used in connection with various embodiments. The signal combiner includes the pixel number 1360, the calibration lookup table 1362, a set of channel weights 3164, and an adder 3166 that combines respective signals 3128, which outputs a combined signal 130. These elements combine in order to output the combined signal 130, which can be output to an image display 131, for example.

The signal combiner of FIG. 31 allows individual channels of data to be combined using a calibration lookup table (LUT) on a pixel-by-pixel basis to create a high-resolution image for display.

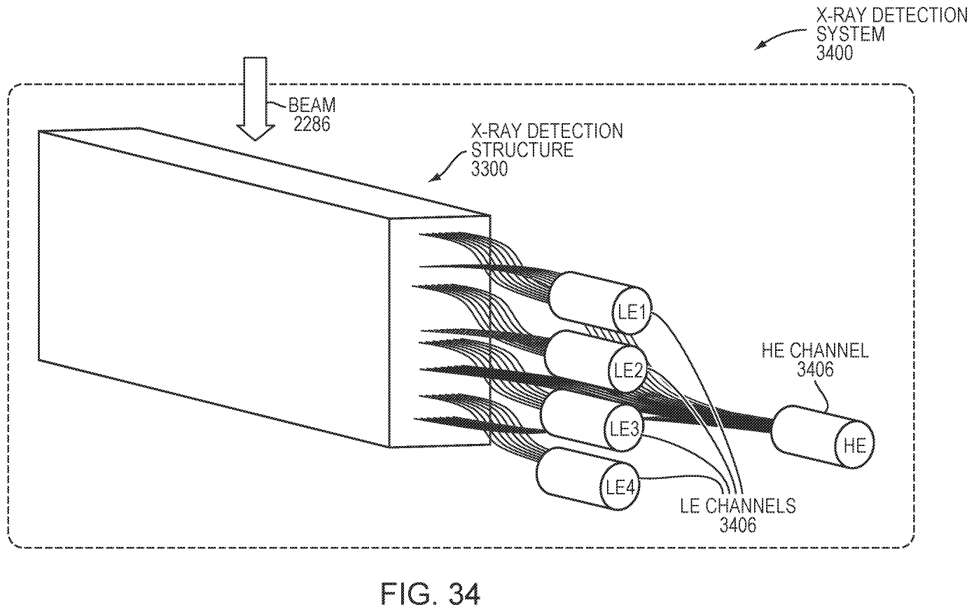

An initial calibration of an embodiment x-ray detection system, such as that illustrated in FIG. 34, with no objects in the beam, can be advantageously implemented to determine which detector channel output (or combination of channel outputs) needs to be used for each position of the scanning beam. For example, if there are 1000 integration periods occurring during a single sweep of the beam across the detector (corresponding to 1000 pixels per image line), the software creating the image can include the lookup table (LUT) 1362 to assign an output signal from a WSF ribbon, or combination of signals from multiple ribbons, to form each pixel, as exemplified in FIG. 31. In the example given above in which two neighboring ribbon signals are combined in a weighted method, for each pixel, the LUT can contain the two ribbon (or “channel”) identifiers and the weighting to be applied to each.

Other embodiments of the calibration process can involve creating multiple LUTs. For example, one LUT can be used for the highest resolution mode for which signals from only one or two ribbons are combined, and another LUT can be used for the highest penetration, lowest resolution mode in which the signals from more ribbons are used to create the image. Additional LUTs can be used for intermediate modes. It should be noted that the operator may be able to select the type of image they would like to view in real-time and can be enabled to switch between the images at any time after the scan data has been acquired.

FIG. 32 is a series of images showing results of a computer simulation showing images of a line pair phantom acquired with a standard prior art detector (left), an embodiment detector with 0.75 inch wide strips of scintillator volume (center), and with 0.5 inch wide strips (right side). In FIG. 32, a transmission image generated by a prior-art unsegmented transmission detector (left) is compared with a detection system that utilizes the x-ray detection structure shown in FIG. 28 with six individual layers of 0.75″ wide scintillator strips (center) and 0.5″ wide strips (right). The steady increase in image resolution can be seen from the left to the right image. The phantom that was imaged in these simulations includes line-pair slots in a steel plate, with slot widths of 10 mm to 17.5 mm.

Note that the strip width and number of layers should preferably be determined from the maximum width of the beam that is expected to be incident on the transmission detector. It is desirable, but not essential, to have the number of layers, multiplied by the strip width, to be less than the maximum beam width at the front face of the detector. This will ensure that only one strip per layer is illuminated by the beam at any location along the length of the detector.

### Certain Present Dual-Energy Embodiments

The embodiments described so far have been single-energy detectors, in which there is no spectral discrimination of the incoming beam. Many transmission imaging applications have a requirement that there be some form of material discrimination. This is typically done using “sandwich” style scintillation detectors, in which a first scintillator volume is sensitive to the low-energy component of the X-ray beam and a second scintillation volume, placed so that it intercepts X-rays that have penetrated the first scintillation volume, is sensitive to the higher-energy component of the X-ray beam. Many of these detectors additionally place a low-energy filter between the two scintillation volumes to enhance the separation in energy to which the two detector channels are sensitive. This filter often includes a thin sheet of 0.25-2.0 mm thick copper, but other filter materials are often used.

A sandwich style dual-energy detector, with either both scintillation volumes read out with WSF, or with only the first scintillation volume intercepted by the beam read out with WSF, has been previously disclosed. An approach taken for dual-energy embodiments in the pending patent application PCT/US2021/047030, referenced above is to use WSF to read out both low-energy (LE) and high-energy (HE) channels, but not to use a sandwich-style detector. This means that a given X-ray cannot traverse both the LE and HE scintillation volumes, but the volumes must be presented to the incident beam side-by-side. The HE channel uses a filter to harden the energy spectrum of any x-rays prior to them entering the HE scintillation volume, or uses a scintillation medium that is more sensitive to the harder X-rays.

In dual-energy embodiments of the present application, a single scintillation volume may be used for both LE and HE channels, advantageously, using the approach described in the previously noted pending patent application PCT/US2021/047030, the description of which is included above. A scintillation material is selected that has strong self-absorption of its own scintillation light and the thickness of the scintillation volume along the incident beam direction is chosen to be greater than the mean free path distance for self-absorption. A suitable example material for x-rays in the range of 100-500 keV is 500 mg/cm² BaFCl phosphor screen, which has a thickness of about 2 mm, and a mean free path for self-absorption of only about 1 mm. Under these conditions, the scintillation light from softer (lower energy) x-rays absorbed close to the entrance surface of the scintillator will mostly be emitted and hence detected at the entrance surface, and little of the light will escape and be detected at the exit surface. Correspondingly, the scintillation light from harder (higher energy) x-rays absorbed deeper in the scintillator will preferentially be emitted and hence detected from the exit surface, and less of the light will escape and be detected at the entrance surface. By using two layers of WSF, one optically coupled to the entrance surface, and one optically coupled to the exit surface of the scintillator, separate signals characterizing the low-energy spectrum and the high energy spectrum of the incident beam can simultaneously be obtained.

FIG. 33 is a side-view illustration of a preferred embodiment x-ray detection structure with dual energy operation, four layers of scintillator strips volumes, and eight WSF ribbons. In this embodiment, each layer of scintillator strips is coupled to two separate WSF ribbons—a LE ribbon 104 optically coupled to the beam entrance surface and a HE WSF ribbon 1004 optically coupled to the beam exit surface. To provide a high-resolution LE image, the LE ribbons can be individually read out with separate individual photodetectors, or for example, with a multi-anode PMT. To provide a high-resolution HE image, the HE ribbons can also be individually read out with separate individual photodetectors, or with a multi-anode PMT. Alternatively, all the HE WSF ribbons can be optically combined together and read out with a single photodetector to create a low resolution HE image, as illustrated in FIG. 34. This can be a preferred option that lowers the total number of photodetectors (and electronic readout channels) required, since the HE channel is frequently used only to provide material discrimination for which high resolution is not required

Those skilled in the art will understand that such a detector is able to provide the operator with material discrimination. X-rays transmitted through higher-Z (higher atomic number) materials such as steel have fewer low-energy X-rays remaining in the beam than X-rays passing through lower-Z organic materials, such as water or plastic. By analyzing the relative ratio of detector signals in the low and high energy channels, material discrimination can be performed. This is typically indicated to the operator by applying a color pallet to the image: orange for organic materials with low effective atomic number (Z), green for intermediate-Z materials such as Al, and blue for higher-Z materials such as steel.

Additional embodiments of the system can use an elliptical or rectangular beam profile (rather than a circular or square profile) that is elongated in the direction along the detector width or along the detector length. In this way, resolution can be further optimized in either direction without decreasing the cross-sectional area of the beam (and therefore the intensity of X-rays in it).

FIG. 34 is an end-view, perspective diagram of an embodiment x-ray detection system 3400 that includes the dual-energy x-ray detection structure of FIG. 33, showing optical coupling of LE WSF ribbons from FIG. 33 to individual photodetectors (LE channels 3406) and all of the HE WSF ribbons from FIG. 33 optically coupled together to a single photodetector (HE channel 3406).

Following the FIG. 33 and FIG. 34 descriptions and drawings, and in accordance with the description of the previously referenced PCT application, it will readily be understood that in accordance with various of the present embodiments, an x-ray detection system for detecting a scanning beam of x-rays can include an x-ray detection structure as described above. A plurality of photodetectors optically coupled to respective ends of respective WSF ribbons of respective layers can also be included. The plurality of photodetectors can be configured to detect the respective scintillation photons carried by the respective WSF ribbons and to produce respective signals responsively. The plurality of photodetectors can be a plurality of photomultiplier tubes or a plurality of anodes of a multi-anode photomultiplier tube.

A signal combiner may also be included in the system, the signal combiner configured to combine, selectively, the respective signals from the respective WSF ribbons, for positions of the scanning beam along the respective scan axes, to create a combined signal representing a scan of the target with enhanced spatial resolution. The signal combiner can be configured to use one or more predefined lookup tables to combine the signals from one or more ribbons for each incremental position of the scanning beam along the respective scan axes to create an image. The one or more predefined lookup tables can be created from a scan acquired without the target or other occluding objects positioned between a source of the scanning beam and the x-ray detection structure.

### Certain Other Present Method Embodiments

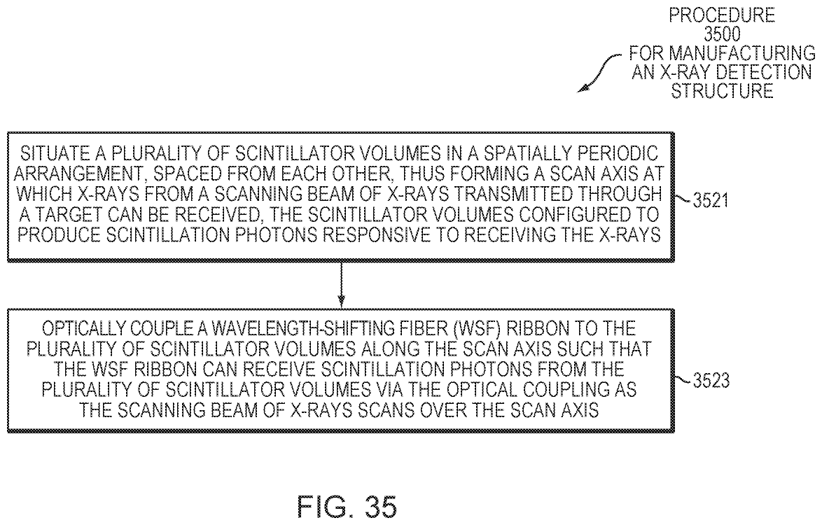

FIG. 29 above described a procedure for building a multi-layer x-ray detection structure embodiment. Nonetheless, more broadly, reference should be made to FIG. 35 for a fuller understanding of the scope of embodiments.

FIG. 35 is a flow diagram illustrating an embodiment procedure 3500 for manufacturing an x-ray detection structure. In simplest form, this can include the structure embodiment of FIG. 27. At 3521, a plurality of scintillator volumes is situated in a spatially periodic arrangement, spaced from each other, thus forming a scan axis at which x-rays from a scanning beam of x-rays transmitted through a target can be received, the scintillator volumes configured to produce scintillation photons responsive to receiving the x-rays.

At 3523, a wavelength-shifting fiber (WSF) ribbon is optically coupling to the plurality of scintillator volumes along the scan axis such that the WSF ribbon can receive scintillation photons from the plurality of scintillator volumes via the optical coupling as the scanning beam of x-rays scans over the scan axis.

The procedure can further include situating a plurality of spacers in a spatially periodic arrangement in the scan axis to transmit x-rays from the scanning beam transmitted through the target, the situating including placing one or more respective spacers of the plurality of spacers between respective pairs of adjacent scintillator volumes of the plurality of scintillator volumes, the spacers being substantially transparent to x-rays. This will be understood in reference to example FIGS. 28-29.

It should further be understood that the method can include assembling any of the elements described herein in connection with embodiment x-ray detection structures and systems, as well as elements of the steps shown in FIG. 29.

While example embodiments have been particularly shown and described, it will be understood by those skilled in the art that various changes in form and details may be made therein without departing from the scope of the embodiments encompassed by the appended claims.

The teachings of all patents, published applications and references cited herein are incorporated by reference in their entirety.

1. An x-ray detection structure comprising:
a plurality of scintillator volumes in a spatially periodic arrangement, the plurality of scintillator volumes spaced from each other and forming a scan axis at which x-rays from a scanning beam of x-rays transmitted through a target can be received, the plurality of scintillator volumes configured to produce scintillation photons responsive to receiving the x-rays; and
a wavelength-shifting fiber (WSF) ribbon optically coupled to the plurality of scintillator volumes along the scan axis, the WSF ribbon configured to receive scintillation photons from the plurality of scintillator volumes as the scanning beam of x-rays scans and causes at least a subset of scintillator volumes in the scan axis to produce the scintillation photons.

2. The x-ray detection structure of claim 1, further including a plurality of spacers in spatially periodic arrangement in the scan axis, the spacers configured to transmit x-rays from the scanning beam transmitted through the target, one or more respective spacers of the plurality of spacers situated between respective pairs of adjacent scintillator volumes of the plurality of scintillator volumes, the spacers being substantially transparent to x-rays.

3. The x-ray detection structure of claim 1, further including one or more light reflectors mechanically fixed with respect to the WSF ribbon and the plurality of scintillator volumes and configured to enhance receipt of the scintillation photons and provide optical isolation.

4. The x-ray detection structure of claim 1, further comprising a support structure to which the plurality of scintillator volumes and the WSF ribbon are mechanically coupled.

5. The x-ray detection structure of claim 1,
each of the scintillator volumes having an entrance surface configured to receive incident x-rays from the scanning beam transmitted through the target and an exit surface configured to pass a portion of the incident x-rays that traverse a thickness of the respective scintillator volume between the entrance surface and the exit surface thereof,
the WSF ribbon being a first WSF ribbon optically coupled to the entrance surface of the scintillator volumes; and
further comprising a second WSF ribbon optically coupled to the exit surface of the scintillator volumes.

6. The x-ray detection structure of claim 5, wherein the thickness of the scintillator volumes is larger than a self-attenuation length of the scintillation photons of a scintillator material of the scintillator volume.

7. The x-ray detection system of claim 1, wherein each scintillator volume of the plurality of scintillator volumes has a dimension of length, width, and/or thickness on the order of 1 mm or on the order of 10 mm.

8. The x-ray detection structure of claim 1, wherein each scintillator volume of the plurality of scintillator volumes has a dimension of length, width, and/or thickness between 1 mm and 10 mm.

9. The x-ray detection structure of claim 1, wherein a scintillator material of the plurality of scintillator volumes comprises one or more materials selected from a group consisting of BaFCl, GOS, YOS, and ZnS.

10. The x-ray detection structure of claim 1, wherein the scintillator volumes comprise 500 mg/cm² BaFCl phosphor screen.

11. The x-ray detection structure of claim 1, wherein the plurality of scintillator volumes are laser-cut or water-jet-cut.

12. The x-ray detection structure of claim 1,
wherein the plurality of scintillator volumes is a first plurality of scintillator volumes, the WSF ribbon is a first WSF ribbon, and the scan axis is a first scan axis,
the detection structure further comprising a plurality of detection layers, a first detection layer of the plurality of detection layers including the first plurality of scintillator volumes and the first WSF ribbon;
respective detection layers of the plurality of detection layers comprising respective pluralities of scintillator volumes in respective spatially periodic arrangements, spaced from each other and forming respective scan axes of the scanning beam of x-rays at which x-rays from the scanning beam transmitted through the target can be received, the respective pluralities of scintillator volumes further configured to produce respective scintillation photons responsive to receiving the x-rays; and
the respective layers of the plurality of layers further including respective WSF ribbons optically coupled to respective pluralities of scintillator volumes along the respective scan axes, respective WSF ribbons configured to receive respective scintillation photons from respective pluralities of scintillator volumes as the scanning beam of x-rays scans and causes at least respective subsets of respective pluralities of scintillator volumes in the respective scan axes to produce the scintillation photons.

13. The x-ray detection structure of claim 12, each respective layer further including a plurality of spacers in spatially periodic arrangement in the respective scan axis, the spacers configured to transmit x-rays from the scanning beam transmitted through the target, one or more respective spacers of the plurality of spacers situated between respective pairs of adjacent scintillator volumes of the plurality of scintillator volumes of the respective layer, the spacers being substantially transparent to x-rays.

14. The x-ray detection structure of claim 12, wherein each scintillator volume of a respective plurality of scintillator volumes of a respective layer is offset, along a direction of the scan axis, from all other scintillator volumes of other layers of the plurality of layers.

15. An x-ray detection system for detecting a scanning beam of x-rays, the detector system comprising:
the x-ray detection structure of claim 12; and
a plurality of photodetectors optically coupled to respective ends of respective WSF ribbons of respective layers, the plurality of photodetectors configured to detect the respective scintillation photons carried by the respective WSF ribbons and to produce respective signals responsively.

16. The x-ray detection system of claim 15, wherein the plurality of photodetectors is a plurality of photomultiplier tubes.

17. The x-ray detection system of claim 15, wherein the plurality of photodetectors is a plurality of anodes of a multi-anode photomultiplier tube.

18. The x-ray detection system of claim 15, further comprising a signal combiner configured to combine, selectively, the respective signals from the respective WSF ribbons, for positions of the scanning beam along the respective scan axes, to create a combined signal representing a scan of the target with enhanced spatial resolution.

19. The x-ray detection system of claim 18, wherein the signal combiner is configured to use one or more predefined lookup tables to combine the signals from one or more ribbons for each incremental position of the scanning beam along the respective scan axes to create an image.

20. The x-ray detection system of claim 19, wherein the one or more predefined lookup tables are created from a scan acquired without the target or other occluding objects positioned between a source of the scanning beam and the x-ray detection structure.

21. A method of manufacturing an x-ray detection structure, the method comprising:
situating a plurality of scintillator volumes in a spatially periodic arrangement, spaced from each other, thus forming a scan axis at which x-rays from a scanning beam of x-rays transmitted through a target can be received, the scintillator volumes configured to produce scintillation photons responsive to receiving the x-rays; and
optically coupling a wavelength-shifting fiber (WSF) ribbon to the plurality of scintillator volumes along the scan axis such that the WSF ribbon can receive scintillation photons from the plurality of scintillator volumes via the optical coupling as the scanning beam of x-rays scans over the scan axis.

22. The method of claim 21, further comprising:
situating a plurality of spacers in a spatially periodic arrangement in the scan axis to transmit x-rays from the scanning beam transmitted through the target, the situating including placing one or more respective spacers of the plurality of spacers between respective pairs of adjacent scintillator volumes of the plurality of scintillator volumes, the spacers being substantially transparent to x-rays.

23. (canceled)

24. An x-ray detection structure comprising:
a plurality of detection layers, each respective detection layer comprising:
a scintillator sub-layer having a plurality of scintillator volumes in a spatially periodic arrangement, the plurality of scintillator volumes spaced from each other and forming a scan axis at which x-rays from a scanning beam of x-rays transmitted through a target can be received, the plurality of scintillator volumes further configured to produce scintillation photons responsive to receiving the x-rays;
a plurality of spacers in the scintillator sub-layer in a spatially periodic arrangement in the scan axis, the spacers configured to transmit x-rays from the scanning beam transmitted through the target, one or more respective spacers of the plurality of spacers situated between respective pairs of adjacent scintillator volumes of the plurality of scintillator volumes, the spacers being substantially transparent to x-rays;
a wavelength-shifting fiber (WSF) ribbon sub-layer optically coupled to the plurality of scintillator volumes along the scan axis, the WSF ribbon configured to receive scintillation photons from the plurality of scintillator volumes as the scanning beam of x-rays scans and causes at least a subset of scintillator volumes in the scan axis to produce the scintillation photons; and
a reflective sub-layer comprising a light reflector mechanically fixed with respect to the WSF ribbon and the plurality of scintillator volumes and configured to isolate, optically, the detection layer from other detection layer(s) of the plurality of detection layers.

25. The x-ray detection structure of claim 24, wherein each scintillator volume of a respective scintillator sub-layer is offset, along a direction of the scan axis, from all other scintillator volumes of respective scintillator sub-layers.

26. An x-ray detection system comprising:
the x-ray detection structure of claim 24; and
a plurality of photodetectors optically coupled to respective ends of respective WSF ribbons of respective layers, the plurality of photodetectors configured to detect the respective scintillation photons carried by the respective WSF ribbons and to produce respective signals responsively.

27. (canceled)
